(19) United States
(12) Patent Application Publication
(10) Pub. No.: US 2026/0061693 A1
(43) Pub. Date: Mar. 5, 2026

(54) 3D PRINTING OF ELASTOMERIC BLOCK COPOLYMERS WITH TAILORED MECHANICAL PROPERTIES

(71) Applicant: The Trustees of Princeton University, Princeton, NJ (US)

(72) Inventors: Emily Davidson, Princeton, NJ (US); Alice Fergerson, Princeton, NJ (US)

(73) Assignee: The Trustees of Princeton University, Princeton, NJ (US)

(21) Appl. No.: 19/308,833

(22) Filed: Aug. 25, 2025

Related U.S. Application Data
(60) Provisional application No. 63/687,991, filed on Aug. 28, 2024.

(51) Int. Cl. B29C 64/118; B29C 64/227; B29C 64/295; B29K 21/00; B33Y 10/00; B33Y 70/00

(52) U.S. Cl. CPC B29C 64/118; B29C 64/227; B29C 64/295; B29K 2021/003; B33Y 10/00; B33Y 70/00

(57) ABSTRACT

A method for printing via a high operating temperature direct ink writing process is disclosed. The method comprises extruding a filament by causing a filament material, which includes a thermoplastic elastomer, to experience a shear rate of at least 1 s⁻¹ within a print nozzle, increasing anisotropy by increasing a translational velocity of a print nozzle to achieve a draw ratio>1, and then annealing the filament. Also provided is a component formed via 3D printing, comprising a layer from a 3D printed filament composed of an anisotropic nanostructured thermoplastic elastomer, where at least one portion of the component has at least two macro segments arranged linearly in series or a combination of segments both in series and in parallel, where the at least two macro segments are configured to tune the mechanical functionality of the at least one portion of the component.

### CROSS-REFERENCE TO RELATED APPLICATIONS

This application claims priority to U.S. Application No. 63/687,991, filed Aug. 28, 2024, which is hereby incorporated by reference in its entirety.

### STATEMENT REGARDING FEDERALLY SPONSORED RESEARCH OR DEVELOPMENT

This invention was made with government support under Grant Numbers DMR-2011750 and DMR-1420541 awarded by the National Science Foundation. The government has certain rights in the invention.

### TECHNICAL FIELD

The present disclosure relates to three-dimensional printing processes, and more particularly to controlling 3D printing parameters to produce soft architectures with mechanically tailored properties through high operating temperature direct ink writing of elastomeric block copolymers.

### BACKGROUND

Additive manufacturing, particularly three-dimensional printing, has emerged as a transformative technology for creating complex geometries and functional components across various industries. Among the different 3D printing approaches, material extrusion techniques have gained widespread adoption due to their versatility, cost-effectiveness, and ability to process a broad range of materials. These techniques involve heating thermoplastic materials to their processing temperature and extruding them through a nozzle to build objects layer by layer.

Traditional 3D printing materials, such as polylactic acid and acrylonitrile butadiene styrene, provide adequate structural properties for many applications but lack the flexibility and elastomeric characteristics needed for soft robotics, wearable devices, and biomedical applications. The development of soft, flexible 3D printed components has become increasingly desirable as applications expand into areas requiring materials that can undergo large deformations while maintaining structural integrity.

Thermoplastic elastomers represent a class of materials that combine the processing advantages of thermoplastics with the elastic properties of rubber. These materials consist of block copolymers with alternating hard and soft segments that create a microphase-separated structure. The hard segments provide mechanical strength and processability, while the soft segments contribute elasticity and flexibility. This unique molecular architecture allows thermoplastic elastomers to be processed using conventional thermoplastic processing techniques while exhibiting rubber-like properties at service temperatures.

The mechanical properties of block copolymers are influenced by their nanostructure, which can form various morphologies including spheres, cylinders, and lamellae depending on the relative volume fractions of the constituent blocks. The orientation and alignment of these nanostructures can affect the anisotropic mechanical behavior of the material. However, controlling nanostructure orientation during processing remains challenging, particularly in additive manufacturing where complex flow fields and rapid cooling rates can influence the final material properties.

Current approaches to creating anisotropic properties in 3D printed materials often rely on incorporating fillers or reinforcing agents into the polymer matrix. While these approaches can enhance certain properties, they may compromise other characteristics such as flexibility, transparency, or processability. Additionally, the incorporation of fillers can complicate the recycling and reprocessing of the materials, limiting their sustainability.

The ability to program mechanical properties spatially within a single printed component would enable the creation of architectures with tailored functionality. Such capability could allow for the design of structures with regions of varying stiffness, enabling controlled deformation patterns and strain localization. This level of mechanical programming could benefit applications ranging from protective equipment to soft robotics, where different regions of a component may require different mechanical responses.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for printing via a high operating temperature direct ink writing (HOT-DIW) process is provided. The method comprises extruding a filament along a print path by causing a filament material to experience a shear rate (\dot{γ}) of at least 1 s⁻¹ within a print nozzle, the filament material including a thermoplastic elastomer (TPE). The method further comprises increasing anisotropy by increasing a translational velocity of a print nozzle to achieve a draw ratio (D_{R})>1. The method also comprises, after extruding the filament, thermally annealing the filament.

According to other aspects of the present disclosure, the method may include one or more of the following features. Extruding the filament may include extruding an unsupported portion of the filament, where the unsupported portion extends an axial distance that is up to 10 times a diameter of the filament. The print path may form a three-dimensional object where at least one portion of the three-dimensional object has at least two macro segments arranged linearly in series or a combination of segments both in series and in parallel, where the at least two macro segments are configured to tune the mechanical functionality of the at least one portion of the three-dimensional object. The at least two macro segments may include at least one stiffer segment and at least one softer segment. The print path may form multiple layers. Each at least one stiffer segment may comprise at least two layers disposed in a direction parallel to a predetermined direction of tension, compression, or flexion of the at least two layers. Each at least one softer segment may comprise at least two layers disposed in a direction perpendicular to a predetermined direction of tension, compression, or flexion of the at least two layers. The TPE may be a multiblock copolymer. The TPE may be a copolymer having at least one glassy block and at least one elastomeric block. The diblock or triblock copolymer may be a styrene-ethylene-butylene-styrene (SEBS) polymer. The filament material may include the TPE and at least one functional additive material. The at least one functional additive material may be a fluorescent or phosphorescent material. The thermal annealing temperature may be a temperature between the glass transition temperature (T_{g}) and either the degradation temperature or a nearest nanostructural transition temperature. The thermal annealing may be performed for a period of time of no more than 2 weeks.

According to another aspect of the present disclosure, a component formed via three-dimensional (3D) printing is provided. The component comprises at least one layer from a 3D printed filament, the 3D printed filament being composed of an anisotropic nanostructured thermoplastic elastomer (TPE). At least one portion of the component has at least two macro segments that are arranged linearly in series with respect to the direction of intended deformation, or a combination of segments both in series and in parallel with respect to the direction of intended deformation, where the at least two macro segments are configured to tune the mechanical functionality of the at least one portion of the component, or where at least one portion of the component has at least one macro segment having programmed anisotropy via extrusion.

According to other aspects of the present disclosure, the component may include one or more of the following features. For a given orientation of the component, the at least two macro segments may include at least one stiffer segment and at least one softer segment. Each at least one stiffer segment may comprise at least two layers disposed in a direction parallel to a predetermined direction of tension and compression of the at least two layers. Each at least one softer segment may comprise at least two layers disposed in a direction perpendicular to a predetermined direction of tension and compression of the at least two layers. The anisotropic nanostructured TPE may be a copolymer having at least one glassy block and at least one elastomeric block. The 3D printed filament being composed may be composed of the anisotropic nanostructured TPE and at least one functional additive material.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a method for printing via a high operating temperature direct ink writing process, according to aspects of the present disclosure.

FIG. 2 depicts a schematic illustration of the printing process of FIG. 1, according to an embodiment.

FIG. 3 shows a schematic illustration of a micro-phase separated cylindrical nanostructure, according to aspects of the present disclosure.

FIG. 4 illustrates images of dog-bone samples with programmed nanostructure alignment and stress-strain curves, according to an embodiment.

FIG. 5 depicts a 3D printed architecture with directionally soft and stiff regions in series, according to aspects of the present disclosure.

FIG. 6 shows a 3D printed architecture with directionally soft and stiff regions in series and parallel, according to an embodiment.

FIGS. 7A-7B are graphs showing (7A) mechanical anisotropy via E_{∥} and (7B) structural anisotropy via <P₂> as a function of \dot{γ}ₘₐₓ (at a fixed D_{R}=1) and post-printing thermal annealing. The dotted gray line indicates a transition between distinct regimes, representing the onset of significant trapped stresses which relax upon thermal annealing. The approximate print direction is denoted by an arrow in each image. Side-on views of PS domain geometry and continuity (left) and end-on views of PS cylinder cross-sections (right) are included.

FIG. 7C is a graph showing full width half maximum (FWHM) extracted from small-angle x-ray scattering (SAXS), indicating a transition in behavior upon thermal annealing at the critical printing rate.

FIGS. 8A-8B are TEM images of samples printed at \dot{γ}ₘₐₓ=0.09 s⁻¹ (8A) upon 3D printing and (8B) after thermal annealing. The approximate print direction is denoted by an arrow in each image. Side-on views of PS domain geometry and continuity (left) and end-on views of PS cylinder cross-sections (right) are included.

FIGS. 8C-8D are TEM images of samples printed at \dot{γ}ₘₐₓ=90 s⁻¹ (8C) upon 3D printing and (8D) after thermal annealing. The approximate print direction is denoted by an arrow in each image. Side-on views of PS domain geometry and continuity (left) and end-on views of PS cylinder cross-sections (right) are included.

FIGS. 9A-9B are graphs showing (9A) mechanical anisotropy via E_{∥} and (9B) structural anisotropy via <P₂> as a function of D_{R} (at a fixed \dot{γ}ₘₐₓ=90 s⁻¹) and post-printing thermal annealing.

FIG. 9C is a graph showing FWHM extracted from SAXS, indicating a larger magnitude of nanostructure rearrangement upon thermal annealing at higher draw ratio conditions.

FIG. 10 is an illustration of a zoomed in portion of a 3DP log-pile structure demonstrating the ability to produce spanning structures without sagging.

FIG. 11A is an image showing 3DP vases demonstrating the ability to produce high aspect ratio structures without lower layers collapsing, as well as moderate unsupported overhangs.

FIG. 11B is an image showing 3DP SEBS/d₂₄-cHBC composite flowers inside a 3DP SEBS vase, demonstrating incorporation of functional additives. Here the yellow-colored small molecule is excited by UV-excitation and exhibits long-lived (>20 sec) red emission after UV exposure stops.

FIG. 11C is an image showing 3DP “Princeton” text displaying high print path fidelity maintained over 5 layers, including in difficult print path scenarios such as U-turns and right angles.

FIG. 12A is an image showing tensile strain isolation obtained in a three-segment strip by organizing directionally soft and stiff components in series.

FIG. 12B is an image showing further controlled strain localization in a five-segment strip by organizing soft and stiff components in series and in parallel.

FIGS. 13A-13B are images showing multi-layer architectures exhibit tunable flexural strain behavior, demonstrated via the degree of bending occurring under a 100 g weight for perpendicular (13A) and parallel (13B) orientations.

FIG. 13C is an image showing controlled localization of flexural strain to the central segment of the architecture from FIG. 12A.

FIG. 14A is a graph showing recoverability of mechanical anisotropy via thermal annealing after samples have been strained beyond yielding.

FIG. 14B are images showing self-healing behavior of TPEs, achieved via thermal annealing.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

High operating temperature direct ink writing (HOT-DIW) represents a form of material extrusion additive manufacturing that enables the processing of thermoplastic elastomers at elevated temperatures. This manufacturing approach allows for the controlled application of shear and extensional flows along programmable print paths, providing a mechanism for inducing structural alignment in nanostructured materials. The process may leverage the inherent properties of thermoplastic elastomers, which are comprised of block copolymers that microphase separate into ordered nanostructures due to the incompatibility between chemically distinct blocks. These materials can be melt-processed at temperatures above their glass transition temperature while behaving as soft elastic solids below this temperature.

The HOT-DIW process may enable the fabrication of soft architectures with mechanically tailored properties through the strategic control of printing parameters. By varying factors such as shear rates, extensional flows, and draw ratios during the extrusion process, the alignment and orientation of nanostructures within the printed material can be controlled. This control over nanostructural alignment may translate to anisotropic mechanical properties in the resulting printed components. The process may also incorporate post-printing thermal annealing steps that can enhance the degree of structural and mechanical anisotropy achieved during the printing process.

Thermoplastic elastomers suitable for HOT-DIW processing may include multiblock copolymers with alternating glassy and elastomeric segments. These materials may exhibit shear-thinning behavior during melt processing, which facilitates flow within printing nozzles, while also possessing yield stress characteristics that allow printed structures to maintain their intended geometry upon deposition. The combination of these rheological properties makes such materials well-suited for extrusion-based additive manufacturing processes. Additionally, the thermoplastic nature of these materials may enable reprocessability and recyclability through multiple melt-processing cycles without the degradation typically associated with chemically crosslinked elastomers.

The ability to control material properties along a print path may enable the fabrication of architectures with spatially varying mechanical functionality. By organizing regions of different stiffness in series, parallel, or angular arrangements, printed structures can be designed to exhibit controlled strain localization and directional mechanical responses. This approach to mechanical programming may be achieved through the selective orientation of nanostructures during the printing process, creating macro-scale segments with distinct mechanical properties within a single printed component. Such control over mechanical functionality may be enhanced through the application of specific thermal annealing protocols that promote the development of long-range structural continuity in the printed material.

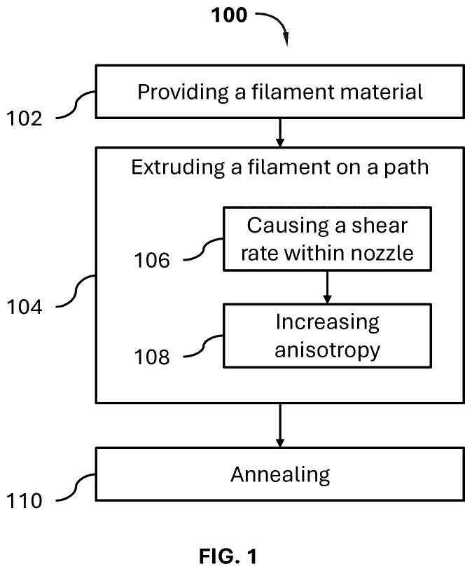

Referring to FIG. 1, a method 100 for printing via a high operating temperature direct ink writing (HOT-DIW) process may include several sequential operations that enable the fabrication of mechanically tailored soft architectures. The method 100 may begin with a step 102 of providing filament material that includes a thermoplastic elastomer. The method 100 may continue with a step 104 of extruding a filament along a print path, which may involve multiple sub-operations for controlling the structural properties of the extruded material. Following the extrusion process, the method 100 may include a step 110 of annealing the filament to enhance the mechanical and structural properties of the printed component.

The step 102 of providing filament material may accommodate various material supply configurations depending on the specific processing requirements and scale of the manufacturing operation. In some cases, the method 100 may be fed by a spooled filament feed system, which may provide continuous material supply for extended printing operations. Alternatively, the method 100 may utilize a hot syringe pump type extruder that may enable precise volumetric control of material flow rates during the printing process. In other implementations, the method 100 may employ a pellet extruder system, where raw thermoplastic elastomer pellets may be fed directly into a heated processing chamber and melted prior to extrusion. Each of these material supply approaches may offer distinct advantages in terms of material handling, processing control, and scalability for different manufacturing applications.

The step 104 of extruding a filament along a print path may represent the core manufacturing operation of the method 100, where the thermoplastic elastomer material may be processed under controlled thermal and mechanical conditions. This step 104 may involve the application of specific shear rates and extensional flows within a print nozzle to induce structural alignment in the nanostructured material. The print path may be programmed to create complex three-dimensional geometries while maintaining precise control over the local material properties throughout the printed structure. During the step 104, the translational velocity of the print nozzle may be adjusted relative to the material flow rate to achieve desired draw ratios that may influence the degree of anisotropy in the extruded filament.

As shown in FIG. 1, the step 110 of annealing the filament may occur after the completion of the extrusion process and may serve to enhance the structural and mechanical properties developed during printing. The annealing process may involve the application of controlled thermal conditions that may promote structural rearrangements and stress relaxation in the printed material. This thermal treatment may enable the development of long-range structural continuity and may enhance the mechanical anisotropy achieved during the extrusion step 104. The step 110 may be performed under specific temperature and time conditions that may be selected based on the thermal properties of the thermoplastic elastomer material and the desired final properties of the printed component.

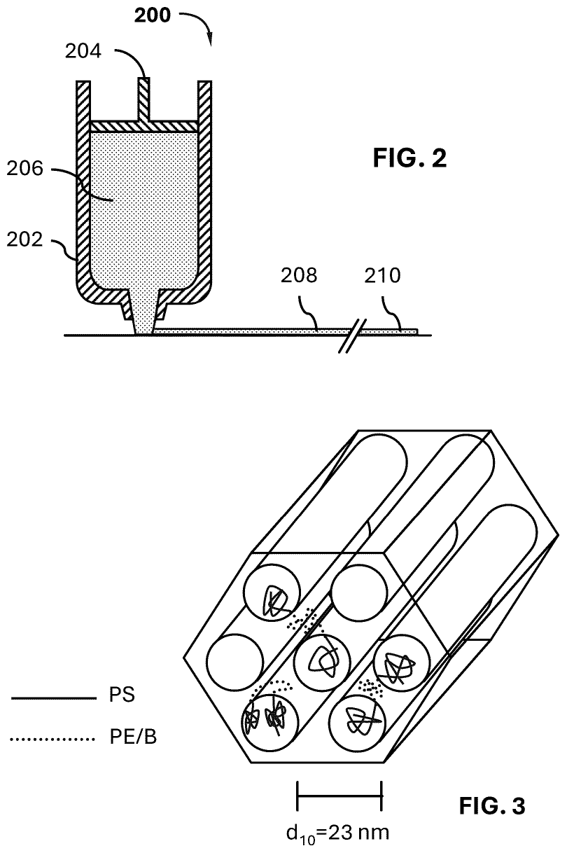

Referring to FIG. 2, a system 200 for implementing the method 100 may include various components configured to enable precise control over the HOT-DIW process. The system 200 may incorporate a heated volumetric extruder that may provide controlled material flow and thermal management during the printing operation. In some cases, the system 200 may include a nozzle body 202 that may serve as the primary processing chamber for the thermoplastic elastomer material. The nozzle body 202 may be constructed from materials that may withstand the elevated temperatures and pressures associated with the extrusion process while maintaining dimensional stability throughout extended printing operations.

The system 200 may further include a plunger 204 that may be positioned within the nozzle body 202 to provide controlled volumetric displacement of the filament material 206. The plunger 204 may be actuated by a stepper motor driven mechanism that may enable precise control over material flow rates during the printing process. In some cases, the plunger 204 may be fitted with sealing elements that may prevent material leakage while allowing smooth translational movement within the nozzle body 202. The plunger 204 may be constructed from materials that may resist chemical interaction with the thermoplastic elastomer while maintaining structural integrity at processing temperatures.

With continued reference to FIG. 2, the nozzle body 202 may incorporate a stainless steel reservoir with a capacity that may accommodate extended printing operations without frequent material replenishment. In some cases, the reservoir may have a capacity of approximately 50 mL and may feature an inner diameter that may facilitate uniform material flow and temperature distribution. The nozzle body 202 may be mounted within an aluminum heating block that may provide uniform thermal distribution throughout the processing chamber. The heating block may be equipped with heating cartridges that may deliver controlled thermal energy to maintain the filament material 206 at processing temperatures. In some cases, the heating cartridges may provide power densities that may enable rapid thermal response and stable temperature control during the printing process.

The system 200 may incorporate temperature control mechanisms that may maintain the filament material 206 at temperatures that may facilitate smooth extrusion while avoiding thermal degradation. In some cases, the nozzle body 202 may operate at temperatures of approximately 160° C., which may enable the thermoplastic elastomer to flow smoothly through the extrusion orifice while preventing melt-flow instabilities that may compromise print quality. The temperature control system may include a PID controller that may provide precise thermal regulation based on feedback from temperature sensing elements positioned adjacent to the nozzle exit. The temperature sensing elements may include thermocouple devices that may provide real-time monitoring of the thermal conditions within the nozzle body 202.

As further shown in FIG. 2, the system 200 may include substrate heating capabilities that may enhance adhesion between the extruded material and the printing surface. The substrate heating system may maintain the printing surface at temperatures that may promote proper bonding of the first deposited layer while providing thermal conditions that may facilitate controlled cooling of subsequent layers. In some cases, the substrate may be heated to temperatures ranging from approximately 85° C. to 90° C., which may provide adequate adhesion for the thermoplastic elastomer while allowing controlled solidification of the extruded filament material 206. The substrate heating may be achieved through heated platform systems that may incorporate temperature control mechanisms similar to those used for the nozzle body 202, enabling coordinated thermal management throughout the printing process.

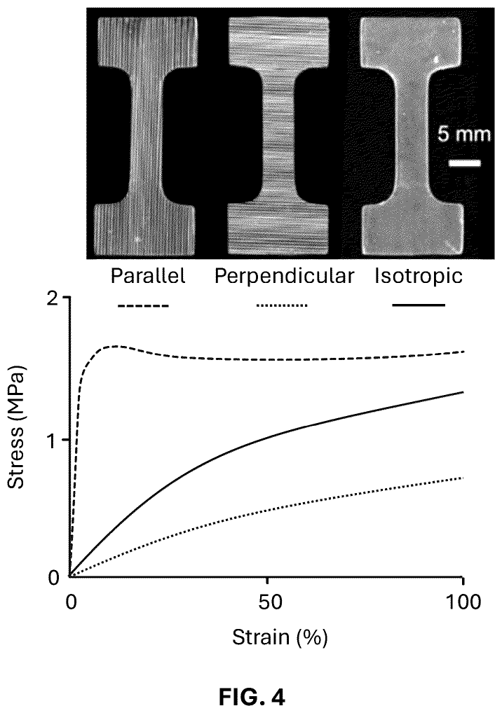

Referring to FIG. 3, the filament material 206 may comprise thermoplastic elastomers that may exhibit complex nanostructural arrangements at the molecular level. The thermoplastic elastomers may be characterized by multiblock copolymer architectures that may include alternating sequences of chemically distinct polymer segments. These multiblock copolymers may encompass diblock configurations with two distinct polymer blocks, triblock arrangements with three polymer segments, tetrablock structures containing four polymer blocks, pentablock compositions with five distinct segments, or higher-order multiblock architectures with six or more polymer blocks. The molecular architecture of these multiblock copolymers may determine the resulting nanostructural geometry and mechanical properties of the filament material 206 after processing through the system 200.

The multiblock copolymer structure of the filament material 206 may incorporate at least one glassy block and at least one elastomeric block that may provide the thermoplastic elastomer with its characteristic mechanical properties. The glassy blocks may exhibit glass transition temperatures above ambient conditions and may serve as physical crosslinking sites that may provide structural integrity to the material. The elastomeric blocks may remain flexible at operating temperatures and may contribute to the elastic recovery properties of the thermoplastic elastomer. The incompatibility between the glassy and elastomeric blocks may drive microphase separation processes that may result in the formation of ordered nanostructures within the filament material 206. These nanostructures may include cylindrical arrangements where one phase may form continuous cylindrical domains within a matrix of the other phase.

As shown in FIG. 3, the microphase separated cylindrical nanostructure may be characterized by regular spacing between adjacent cylindrical domains. A cylinder spacing d₁₀ may represent the distance between parallel cylindrical structures within the nanostructured material and may influence the mechanical and optical properties of the processed filament material 206. The cylinder spacing d₁₀ may be determined by factors including the molecular weights of the individual polymer blocks, the volume fractions of each phase, and the degree of incompatibility between the glassy and elastomeric segments. In some cases, the cylinder spacing d₁₀ may range from approximately 15 nanometers to 30 nanometers depending on the specific molecular architecture of the multiblock copolymer. The regularity and alignment of these cylindrical nanostructures may be influenced by the processing conditions applied during the step 104 of extruding the filament material 206 through the nozzle body 202.

The filament material 206 may include styrene-ethylene-butylene-styrene (SEBS) polymers as representative examples of triblock copolymer compositions suitable for the method 100. SEBS polymers may feature polystyrene end blocks that may serve as the glassy phase and a polyethylene-butylene midblock that may function as the elastomeric phase. The polystyrene blocks may provide structural reinforcement through physical crosslinking below their glass transition temperature, while the polyethylene-butylene midblock may contribute flexibility and elastic recovery properties. The molecular weight distribution and block ratios of SEBS polymers may be tailored to achieve specific nanostructural geometries and mechanical properties in the processed filament material 206. In some cases, SEBS polymers may exhibit cylinder-forming morphologies where the polystyrene domains may form continuous cylindrical structures within the polyethylene-butylene matrix.

With continued reference to FIG. 3, the filament material 206 may incorporate functional additive materials that may enhance the performance characteristics or provide additional functionality to the processed components. These functional additive materials may include fluorescent compounds that may absorb electromagnetic radiation at specific wavelengths and emit light at different wavelengths. Alternatively, the functional additive materials may comprise phosphorescent compounds that may continue to emit light for extended periods after the excitation source has been removed. In some cases, the filament material 206 may include perdeuterated contorted hexabenzocoronene (d₂₄-cHBC) as a phosphorescent additive that may provide long-lived red emission properties. The d₂₄-cHBC additive may be incorporated into the thermoplastic elastomer matrix at concentrations that may provide the desired optical properties without compromising the mechanical performance or processability of the filament material 206.

The incorporation of functional additive materials into the filament material 206 may be achieved through melt-compounding processes that may distribute the additives uniformly throughout the thermoplastic elastomer matrix. The melt-compounding process may involve heating the thermoplastic elastomer and functional additives to temperatures above the glass transition temperature of the glassy blocks while applying mechanical mixing to achieve homogeneous distribution. The compatibility between the functional additives and the polymer matrix may influence the final distribution and performance of the additive materials within the processed components. In some cases, the functional additives may preferentially partition into specific phases of the microphase separated structure, which may affect the optical or other functional properties of the final printed components. The concentration of functional additives may be selected to balance the desired functional performance with the mechanical properties and processability requirements of the filament material 206 during the step 104 of the method 100.

The step 104 of extruding a filament along a print path may involve precise control over multiple process parameters that may influence the structural and mechanical properties of the deposited material. The extrusion process may be characterized by the application of controlled shear rates within the nozzle body 202, where the filament material 206 may experience shear deformation as the material flows through the constricted geometry of the extrusion orifice. The magnitude of the applied shear rate may be determined by factors including the volumetric flow rate of the filament material 206, the internal diameter of the nozzle exit, and the rheological properties of the thermoplastic elastomer at processing temperatures. In some cases, the filament material 206 may experience shear rates ranging from approximately 0.01 s⁻¹ to values exceeding 100 s⁻¹ depending on the specific processing conditions and desired material properties.

The lower range of shear rates that may be applied during the step 104 may extend to values as low as 0.01 s⁻¹ or 0.05 s⁻¹, which may enable processing under conditions that may minimize disruption of the existing nanostructural arrangements within the filament material 206. These lower shear rate conditions may be achieved through the use of larger nozzle diameters, reduced volumetric flow rates, or combinations of processing parameters that may reduce the magnitude of shear deformation experienced by the material during extrusion. The application of lower shear rates may result in printed filaments that may retain more of the original nanostructural organization present in the unprocessed thermoplastic elastomer, though such conditions may also result in extended processing times for complex geometries. The selection of appropriate shear rate conditions may depend on the balance between processing efficiency and the desired degree of nanostructural modification during the extrusion process.

A step 106 of causing the filament material 206 to experience controlled shear rates within the nozzle body 202 may be accompanied by the simultaneous application of extensional strain to the material during the extrusion process. The extensional strain may result from the convergent flow geometry within the nozzle body 202 and may contribute to the alignment of nanostructural features within the filament material 206. The magnitude of extensional strain experienced by the filament material 206 may range from approximately 2% to 100% depending on the specific nozzle geometry, flow conditions, and material properties. The extensional strain may be distributed non-uniformly across the cross-section of the extruded filament, with higher strain levels typically occurring along the centerline of the flow where the material may experience the greatest degree of convergent deformation. The combination of shear and extensional deformation during the step 106 may contribute to the development of anisotropic nanostructural arrangements that may influence the mechanical properties of the deposited material.

A step 108 of increasing anisotropy through controlled adjustment of translational velocity may involve the coordination of nozzle movement with material flow rates to achieve specific draw ratios during the extrusion process. The draw ratio may be defined as the ratio of the cross-sectional area of the nozzle exit to the cross-sectional area of the deposited filament, which may be controlled by varying the translational velocity of the nozzle body 202 relative to the volumetric flow rate of the filament material 206. When the translational velocity exceeds the average material velocity, the deposited filament may exhibit a reduced cross-sectional area compared to the nozzle diameter, resulting in draw ratios greater than unity. The application of draw ratios greater than unity may induce additional extensional deformation in the filament material 206 as the material transitions from the nozzle exit to the deposition substrate, which may enhance the degree of nanostructural alignment achieved during the extrusion process.

The step 108 may enable the formation of unsupported portions of the extruded filament that may span distances between deposition points without requiring intermediate support structures. These unsupported portions may extend axial distances that may be at least 10 times the diameter of the filament, demonstrating the structural integrity that may be achieved through proper control of the extrusion parameters and material properties. In some cases, the unsupported portions may extend distances that may exceed 15 times or 20 times the filament diameter, depending on the specific rheological properties of the filament material 206 and the environmental conditions during the printing process. The ability to create extended unsupported spans may enable the fabrication of complex geometries including overhanging features, bridging structures, and hollow internal cavities without the need for sacrificial support materials that may complicate the manufacturing process or compromise the final component properties.

The method 100 may incorporate recognition of a threshold shear rate condition that may influence the effectiveness of subsequent thermal treatment processes. This threshold condition, which may occur at shear rates of approximately 1 s⁻¹, may represent a transition point above which the thermal annealing step 110 may provide enhanced improvements in structural and mechanical anisotropy. Below this threshold shear rate, the filament material 206 may retain sufficient nanostructural organization during the extrusion process such that thermal annealing may provide limited additional benefits. Above the threshold shear rate, the extrusion process may introduce structural disruptions or trapped stresses that may be resolved through the thermal annealing step 110, resulting in improved final properties compared to the as-printed condition. The recognition of this threshold condition may enable optimization of the processing parameters to achieve desired material properties while minimizing processing time and energy consumption.

The step 104 may incorporate specific geometric relationships for controlling the spatial arrangement of deposited material during multi-layer printing operations. The layer height for successive deposition passes may be calculated using the relationship H=\sqrt{π/4}×D_{fil,theo}, where D_{fil,theo} represents the theoretical filament diameter based on the volumetric flow rate and translational velocity. This geometric relationship may ensure proper interlayer bonding while maintaining the intended structural geometry throughout the printing process. The interfilament separation distance for adjacent parallel filaments may be determined using the relationship IF=1.075×D_{fil,theo}, which may provide adequate overlap between adjacent filaments to ensure structural continuity while avoiding excessive material accumulation that may disrupt the intended nanostructural alignment. These geometric parameters may be adjusted based on the specific material properties and processing conditions to optimize the balance between structural integrity and material property control throughout the printed component.

The step 110 of annealing the filament may involve the application of controlled thermal conditions to the deposited material 208 following the completion of the extrusion process. The annealing process may serve to enhance the structural organization and mechanical properties that may be developed during the step 104 of extruding the filament material 206 through the nozzle body 202. The thermal treatment may enable molecular rearrangements within the thermoplastic elastomer that may resolve structural disruptions or trapped stresses that may be introduced during the extrusion process. The annealing conditions may be selected based on the thermal properties of the specific thermoplastic elastomer composition and the desired final properties of the printed component.

The annealing temperature may be maintained within a range that may be bounded by the glass transition temperature of the glassy blocks and either the thermal degradation temperature or the nearest nanostructural transition temperature of the thermoplastic elastomer. In some cases, the annealing temperature may range from approximately 140° C. to 160° C., which may provide adequate thermal energy for molecular mobility while avoiding thermal degradation of the polymer chains. The selection of annealing temperature within this range may depend on the specific molecular architecture of the multiblock copolymer and the degree of structural modification desired in the final component. The annealing temperature may be maintained with precision to ensure consistent thermal treatment throughout the printed structure while avoiding temperature excursions that may compromise the material properties or dimensional stability of the component.

The duration of the annealing process may be selected to balance the degree of structural improvement with processing efficiency considerations. In some cases, the annealing may be performed for short periods of less than 60 minutes, with durations of less than 20 minutes being particularly effective for achieving enhanced material properties. These shorter annealing periods may be suitable for applications where rapid processing throughput may be desired while still achieving improvements in structural and mechanical anisotropy. Alternatively, the annealing process may be extended for longer periods that may range up to 1 day, 3 days, 5 days, 1 week, or 2 weeks depending on the specific material composition and the degree of structural optimization required. The longer annealing periods may enable more complete structural rearrangements and may result in enhanced final properties, though such extended treatments may be reserved for applications where the improved performance may justify the additional processing time.

The annealing process may result in the formation of an annealed material 210 that may exhibit enhanced structural and mechanical properties compared to the deposited material 208 in its as-printed condition. The thermal treatment may promote the development of long-range structural continuity within the nanostructured thermoplastic elastomer, which may contribute to improved mechanical performance under applied loads. The annealed material 210 may exhibit orientational order parameters that may range between approximately 0.75 and 0.92, indicating a high degree of nanostructural alignment within the processed component. These orientational order parameters may represent quantitative measures of the extent to which the cylindrical nanostructures within the thermoplastic elastomer may be aligned along preferred directions within the annealed material 210.

The mechanical properties of the annealed material 210 may be characterized by elastic modulus values that may range from approximately 50 MPa to 100 MPa when measured along the direction of nanostructural alignment. These enhanced modulus values may represent substantial improvements compared to the isotropic properties of the unprocessed thermoplastic elastomer and may demonstrate the effectiveness of the combined extrusion and annealing process in developing anisotropic mechanical behavior. The elastic modulus values may be influenced by factors including the degree of nanostructural alignment achieved during the step 104, the annealing temperature and duration, and the molecular architecture of the specific thermoplastic elastomer composition. The annealed material 210 may maintain these enhanced mechanical properties throughout the operating temperature range of the component, providing consistent performance characteristics for the intended application.

The annealing process may be conducted under controlled atmospheric conditions that may prevent oxidative degradation of the thermoplastic elastomer during the thermal treatment. In some cases, the annealing may be performed under an inert gas atmosphere, such as nitrogen, that may exclude oxygen and moisture from the processing environment. The use of inert atmospheric conditions may be particularly beneficial for extended annealing periods where prolonged exposure to elevated temperatures may increase the risk of thermal degradation. The annealing environment may also incorporate temperature monitoring and control systems that may maintain uniform thermal conditions throughout the treatment period and across the entire volume of the printed component.

The effectiveness of the annealing process may be influenced by the processing conditions applied during the step 104 of extruding the filament material 206. Components that may be printed under conditions involving shear rates above the threshold value may exhibit greater improvements in structural and mechanical anisotropy following the annealing treatment compared to components printed under lower shear rate conditions. This relationship between extrusion conditions and annealing effectiveness may enable optimization of the overall processing parameters to achieve desired final properties while minimizing processing time and energy consumption. The annealed material 210 may retain the programmed spatial variations in mechanical properties that may be established during the step 104, enabling the fabrication of components with tailored mechanical functionality throughout their structure.

The mechanical properties of components produced through the HOT-DIW process may be characterized by controlled anisotropic behavior that may result from the strategic alignment of nanostructures during the extrusion and annealing processes. The development of mechanical anisotropy may be directly related to the processing conditions applied during the step 104 and the subsequent thermal treatment in the step 110. The relationship between processing parameters and resulting material properties may enable the fabrication of components with tailored mechanical responses that may be programmed through the selection of appropriate extrusion conditions and thermal treatment protocols. The degree of mechanical anisotropy achieved may be quantified through various measurement techniques that may assess both the structural organization and mechanical performance of the processed components.

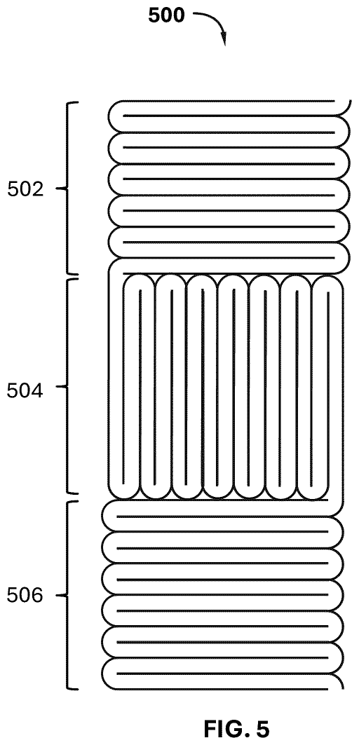

Referring to FIG. 4, the stress-strain behavior of processed components may exhibit directional dependencies that may reflect the underlying nanostructural alignment within the thermoplastic elastomer matrix. Components that may be tested in tension along the direction of nanostructural alignment may demonstrate enhanced stiffness and strength compared to components tested in perpendicular orientations. The stress-strain curves for aligned samples may exhibit higher initial modulus values and may maintain linear elastic behavior over extended strain ranges compared to isotropically oriented control samples. The mechanical response may be influenced by the continuity of the glassy phase domains within the nanostructured material, where enhanced alignment may promote the formation of continuous load-bearing pathways that may contribute to improved mechanical performance.

The orientational order parameters of processed components may provide quantitative measures of the degree of nanostructural alignment achieved through the combined extrusion and annealing processes. These orientational order parameters may range between approximately 0.75 and 0.92 for components processed under optimized conditions, indicating substantial alignment of the cylindrical nanostructures along preferred directions within the material. The magnitude of the orientational order parameter may be influenced by factors including the shear rates applied during extrusion, the draw ratios achieved during deposition, and the thermal conditions applied during the annealing process. Higher orientational order parameters may correlate with enhanced mechanical anisotropy and may indicate more effective alignment of the nanostructural features within the processed component.

With continued reference to FIG. 4, the elastic modulus values of processed components may demonstrate substantial enhancements when measured along the direction of nanostructural alignment. Components that may undergo appropriate processing and thermal treatment may exhibit elastic modulus values ranging from approximately 50 MPa to 100 MPa when tested in the aligned direction. These enhanced modulus values may represent improvements of one to two orders of magnitude compared to the isotropic properties of unprocessed thermoplastic elastomer materials. The elastic modulus enhancement may result from the formation of continuous glassy phase pathways that may provide effective load transfer throughout the component structure. The magnitude of modulus enhancement may depend on the effectiveness of the processing conditions in promoting nanostructural alignment and the subsequent thermal treatment in developing long-range structural continuity.

The relationship between processing conditions and resulting mechanical properties may enable predictive control over the final component characteristics through systematic variation of the extrusion parameters. Components processed under higher shear rate conditions may exhibit greater potential for mechanical property enhancement following thermal annealing, though the as-printed properties may initially appear reduced compared to components processed under lower shear conditions. The application of draw ratios greater than unity during the step 108 may contribute to enhanced mechanical anisotropy by promoting extensional alignment of the nanostructural features during the deposition process. The combination of controlled shear and extensional deformation during extrusion may create conditions that may facilitate the development of highly aligned nanostructures following appropriate thermal treatment.

As further shown in FIG. 4, the flexural behavior of processed components may exhibit controlled directional dependencies that may be tailored through the strategic orientation of nanostructural features during the printing process. Components fabricated with nanostructural alignment parallel to the primary loading direction may demonstrate enhanced flexural stiffness compared to components with perpendicular alignment orientations. The flexural properties may be characterized by specific bending moduli that may vary depending on the orientation of the applied loading relative to the nanostructural alignment direction. Components tested with loading parallel to the alignment direction may exhibit bending moduli of approximately 2.48 MPa, while components tested with perpendicular loading orientations may demonstrate bending moduli of approximately 1.07 MPa. This directional variation in flexural properties may enable the design of components with controlled bending behavior that may be programmed through the selection of appropriate print path orientations.

The controlled flexural strain behavior of processed components may enable the fabrication of structures with localized deformation characteristics that may be tailored for specific mechanical functionality. Components designed with alternating regions of different nanostructural orientations may exhibit controlled strain localization under applied flexural loads, where deformation may be concentrated in regions with reduced flexural stiffness while adjacent regions may remain relatively undeformed. This approach to mechanical programming may enable the creation of components with complex mechanical responses that may be achieved through strategic control of the local nanostructural alignment during the printing process. The ability to control flexural strain distribution may be enhanced through the application of appropriate thermal annealing conditions that may optimize the mechanical contrast between regions of different nanostructural orientations.

The mechanical property control achieved through the HOT-DIW process may be maintained throughout multiple loading cycles, demonstrating the stability of the nanostructural arrangements developed during processing and thermal treatment. Components that may be subjected to repeated loading and unloading cycles may retain their enhanced mechanical properties and anisotropic behavior, indicating that the structural modifications achieved during processing may be stable under typical operating conditions. The mechanical property retention may be attributed to the physical nature of the crosslinking mechanisms within the thermoplastic elastomer, where the glassy phase domains may provide reversible load-bearing capacity without permanent structural degradation. This mechanical stability may enable the use of processed components in applications that may require consistent performance over extended service periods or under cyclic loading conditions.

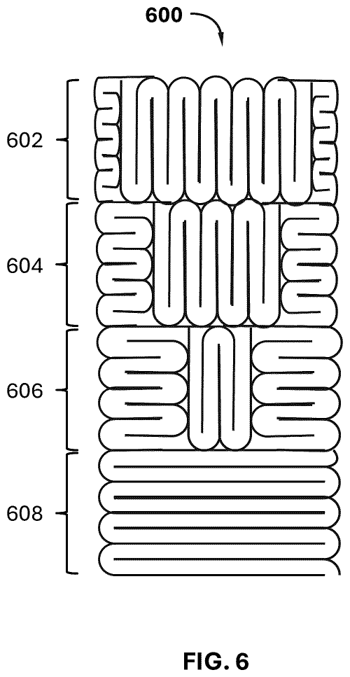

Referring to FIG. 5, the method 100 may enable the fabrication of three-dimensional objects that may incorporate macro segments arranged in series configurations to achieve controlled mechanical functionality. The print path established during the step 104 may form complex three-dimensional geometries where at least one portion of the resulting object may contain at least two macro segments that may be arranged linearly in series. These macro segments may be configured to tune the mechanical functionality of the at least one portion of the three-dimensional object through strategic control of nanostructural alignment and layer organization. The series arrangement of macro segments may enable the creation of components with spatially varying mechanical properties that may respond predictably to applied loads and deformations.

A structure 500 may exemplify the three-dimensional architectures that may be achieved through the controlled arrangement of macro segments in series configurations. The structure 500 may be fabricated through the systematic application of the method 100, where the step 104 of extruding the filament material 206 may be performed along print paths that may create distinct regions with different mechanical characteristics. The structure 500 may demonstrate how the strategic organization of macro segments may enable controlled mechanical responses under applied loading conditions. The formation of the structure 500 may involve the coordination of multiple processing parameters during the step 104, including the control of nozzle translational velocity, volumetric flow rates, and draw ratios to achieve the desired mechanical property variations throughout the component.

The structure 500 may incorporate a first segment 502 that may exhibit specific mechanical characteristics determined by the nanostructural alignment achieved during the extrusion process. The first segment 502 may be formed through the application of controlled processing conditions during the step 104, where the orientation of the print path relative to the intended loading direction may influence the resulting mechanical properties. The first segment 502 may represent one of the at least two macro segments that may be arranged in series within the structure 500. The mechanical properties of the first segment 502 may be further enhanced through the application of the step 110 of annealing, which may promote the development of long-range structural continuity within the nanostructured thermoplastic elastomer matrix.

With continued reference to FIG. 5, the structure 500 may further include a second segment 504 that may be positioned adjacent to the first segment 502 in the series arrangement. The second segment 504 may exhibit mechanical properties that may differ from those of the first segment 502 due to variations in the nanostructural alignment achieved during the printing process. The second segment 504 may be formed through the application of different print path orientations or processing parameters during the step 104, resulting in distinct mechanical characteristics that may complement those of the first segment 502. The interface between the first segment 502 and the second segment 504 may be formed through the continuous deposition of the filament material 206, ensuring structural continuity while maintaining the distinct mechanical properties of each segment.

The structure 500 may also incorporate a third segment 506 that may complete the series arrangement of macro segments within the three-dimensional object. The third segment 506 may be positioned adjacent to the second segment 504 and may exhibit mechanical properties that may be similar to those of the first segment 502 or may represent a third distinct set of characteristics depending on the intended mechanical functionality of the structure 500. The third segment 506 may be formed through the application of controlled processing conditions that may mirror those used for the first segment 502 or may involve different parameters to achieve specific mechanical responses. The series arrangement of the first segment 502, second segment 504, and third segment 506 may create a structure 500 with controlled mechanical functionality that may be tailored for specific loading conditions and performance requirements.

The at least two macro segments within the structure 500 may include at least one stiffer segment and at least one softer segment that may provide controlled mechanical responses under applied loads. The designation of segments as stiffer or softer may be determined by the relative mechanical properties achieved through the strategic control of nanostructural alignment during the step 104. In some cases, the first segment 502 and third segment 506 may function as stiffer segments, while the second segment 504 may serve as a softer segment within the series arrangement. The mechanical contrast between stiffer and softer segments may be achieved through the application of different print path orientations relative to the intended loading direction, where segments with nanostructural alignment parallel to the loading direction may exhibit enhanced stiffness compared to segments with perpendicular alignment.

As further shown in FIG. 5, the formation of the structure 500 may involve the creation of multiple layers through the systematic application of the step 104 across successive deposition passes. The print path may form multiple layers that may be stacked vertically to create the desired three-dimensional geometry while maintaining the intended mechanical property variations throughout the structure 500. Each layer within the structure 500 may be formed through the controlled deposition of the filament material 206 along predetermined paths that may contribute to the overall mechanical functionality of the component. The layer-by-layer construction process may enable precise control over the spatial distribution of mechanical properties throughout the structure 500, allowing for the creation of complex mechanical responses that may be programmed through the selection of appropriate print path strategies.

The at least one stiffer segment within the structure 500 may comprise at least two layers that may be disposed in a direction parallel to a predetermined direction of tension, compression, or flexion of the at least two layers. The parallel orientation of layers within stiffer segments may promote the alignment of nanostructural features along the primary loading direction, resulting in enhanced mechanical properties when loads may be applied in that direction. The formation of stiffer segments may involve the application of print paths that may orient the deposited filament material 206 such that the cylindrical nanostructures within the thermoplastic elastomer may be aligned parallel to the intended loading direction. The at least two layers within each stiffer segment may be deposited with consistent orientations to maintain the mechanical property enhancement throughout the thickness of the segment.

The at least one softer segment within the structure 500 may comprise at least two layers that may be disposed in a direction perpendicular to the predetermined direction of tension, compression, or flexion of the at least two layers. The perpendicular orientation of layers within softer segments may result in nanostructural alignment that may be oriented transverse to the primary loading direction, leading to reduced mechanical stiffness when loads may be applied along that direction. The formation of softer segments may involve the application of print paths that may orient the deposited filament material 206 such that the cylindrical nanostructures may be aligned perpendicular to the intended loading direction. The at least two layers within each softer segment may be deposited with consistent perpendicular orientations to maintain the reduced stiffness characteristics throughout the segment thickness.

The mechanical functionality tuning achieved through the series arrangement of macro segments may enable the structure 500 to exhibit controlled strain localization under applied loads. When tensile, compressive, or flexural loads may be applied to the structure 500, the softer segments may experience greater deformation compared to the stiffer segments due to the differences in mechanical properties achieved through nanostructural alignment control. This controlled strain localization may enable the structure 500 to protect specific regions from excessive deformation while allowing other regions to accommodate the applied loads through controlled deformation. The strain localization behavior may be enhanced through the application of the step 110 of annealing, which may optimize the mechanical contrast between stiffer and softer segments by promoting the development of enhanced nanostructural organization within each segment type.

The three-dimensional architecture of the structure 500 may demonstrate the versatility of the method 100 in creating components with complex mechanical responses that may be achieved through strategic control of processing parameters and print path design. The series arrangement of macro segments may represent one approach to mechanical functionality tuning, though the method 100 may also enable the creation of structures with segments arranged in parallel configurations or combinations of series and parallel arrangements. The structure 500 may serve as a representative example of how the controlled application of shear rates, extensional strains, and draw ratios during the step 104 may be combined with appropriate thermal treatment in the step 110 to achieve three-dimensional objects with tailored mechanical properties that may be programmed through the selection of appropriate processing strategies and print path configurations.

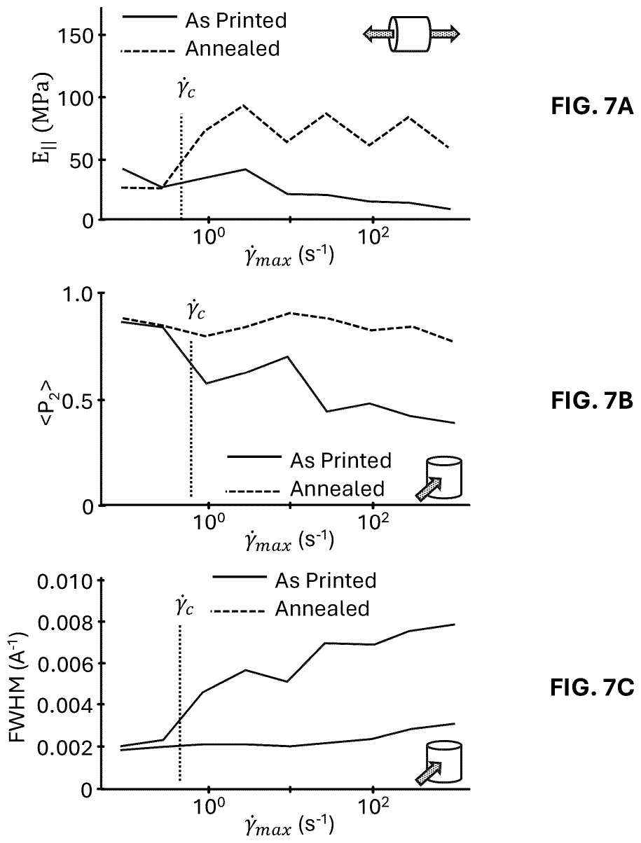

Referring to FIG. 6, the method 100 may enable the fabrication of three-dimensional architectures that may incorporate macro segments arranged in combinations of both series and parallel configurations to achieve enhanced control over mechanical behavior and strain localization. These more complex architectural arrangements may provide greater flexibility in tailoring the mechanical response of printed components compared to purely series configurations. The combination of series and parallel segment arrangements may enable the creation of components with sophisticated mechanical functionality that may be programmed through strategic control of print path design and nozzle translational parameters during the step 104. The enhanced control over strain distribution achieved through these combined configurations may enable applications where precise mechanical responses may be required under various loading conditions.

A structure 600 may exemplify the three-dimensional architectures that may be achieved through the strategic combination of series and parallel macro segment arrangements. The structure 600 may be fabricated through the systematic application of the method 100, where the step 104 of extruding the filament material 206 may be performed along print paths that may create interconnected regions with complementary mechanical characteristics. The structure 600 may demonstrate how the combination of series and parallel arrangements may enable more sophisticated control over strain localization compared to purely linear series configurations. The formation of the structure 600 may involve the coordination of multiple processing parameters during the step 104, including precise control of draw ratios, shear rates, and thermal conditions to achieve the desired mechanical property distributions throughout the interconnected segment network.

The structure 600 may incorporate a first section 602 that may serve as a foundational element within the combined series and parallel arrangement. The first section 602 may be formed through the application of controlled processing conditions during the step 104, where the nozzle body 202 may be translated along predetermined paths to achieve specific nanostructural alignment within the deposited filament material 206. The first section 602 may exhibit mechanical properties that may be determined by the orientation of the cylindrical nanostructures relative to the intended loading directions. The mechanical characteristics of the first section 602 may be enhanced through the application of the step 110 of annealing, which may promote the development of long-range structural continuity within the thermoplastic elastomer matrix and may optimize the mechanical property contrast with adjacent sections.

With continued reference to FIG. 6, the structure 600 may further include a second section 604 that may be positioned to interact mechanically with the first section 602 through either series or parallel load transfer pathways. The second section 604 may be formed through the application of different print path orientations or processing parameters during the step 104, resulting in mechanical properties that may complement or contrast with those of the first section 602 depending on the intended mechanical functionality. The interface between the first section 602 and the second section 604 may be formed through continuous deposition processes that may ensure structural integrity while maintaining the distinct mechanical characteristics of each section. The second section 604 may be configured to work in conjunction with the first section 602 to provide controlled mechanical responses under complex loading conditions that may involve multiple force directions or varying load magnitudes.

The structure 600 may also incorporate a third section 606 that may contribute to the overall mechanical functionality through its position within the combined series and parallel arrangement. The third section 606 may be strategically positioned to interact with both the first section 602 and the second section 604, creating load transfer pathways that may enable sophisticated strain distribution control throughout the structure 600. The third section 606 may be formed through the application of processing conditions that may be selected to achieve specific mechanical properties that may complement the overall architectural design. The positioning and mechanical properties of the third section 606 may enable the structure 600 to exhibit controlled deformation patterns under applied loads, where strain may be distributed according to the relative stiffness characteristics of the interconnected sections and their geometric arrangement.

As further shown in FIG. 6, the structure 600 may include a fourth section 608 that may complete the complex architectural arrangement and may provide additional control over the mechanical response characteristics. The fourth section 608 may be positioned to interact with one or more of the other sections within the structure 600, creating a network of load transfer pathways that may enable precise control over strain localization under various loading scenarios. The fourth section 608 may be formed through the application of controlled processing parameters during the step 104, where the translational velocity of the nozzle body 202 and the volumetric flow rate of the filament material 206 may be coordinated to achieve the desired mechanical properties. The mechanical characteristics of the fourth section 608 may be tailored to work in combination with the other sections to provide enhanced mechanical functionality compared to simpler architectural arrangements.

The combination of series and parallel arrangements within the structure 600 may enable enhanced control over strain localization by providing multiple pathways for load transfer and deformation accommodation. When loads may be applied to the structure 600, the strain distribution may be influenced by both the individual mechanical properties of each section and the geometric relationships between sections within the architectural arrangement. Sections arranged in series may experience uniform stress levels while exhibiting strain levels that may be inversely proportional to their relative stiffness characteristics. Sections arranged in parallel may share applied loads according to their relative stiffness values, with stiffer sections carrying greater load fractions and softer sections experiencing greater strain levels. The combination of these load sharing mechanisms within the structure 600 may enable sophisticated mechanical responses that may be tailored for specific application requirements.

The enhanced mechanical behavior achieved through combined series and parallel configurations may enable the structure 600 to exhibit controlled strain isolation in multiple regions simultaneously. The architectural arrangement may be designed such that applied loads may be distributed among the various sections according to predetermined patterns that may protect sensitive regions while allowing controlled deformation in designated areas. The strain isolation capabilities may be enhanced through the strategic selection of processing parameters during the step 104, where different sections may be formed with varying degrees of nanostructural alignment to achieve the desired mechanical property contrasts. The step 110 of annealing may further optimize the mechanical property distribution by promoting enhanced structural organization within each section while maintaining the interfaces between sections that may enable effective load transfer throughout the structure 600.

The complex architectural arrangements exemplified by the structure 600 may demonstrate the versatility of the method 100 in creating components with sophisticated mechanical functionality that may exceed the capabilities of simpler geometric configurations. The combination of series and parallel segment arrangements may enable the creation of components that may respond predictably to complex loading conditions involving multiple force directions, varying load magnitudes, or time-dependent loading patterns. The mechanical programming achieved through these architectural approaches may be further enhanced through the incorporation of functional additive materials within the filament material 206, which may provide additional functionality such as sensing capabilities or environmental responsiveness. The structure 600 may represent one example of how the controlled application of processing parameters during the step 104, combined with appropriate thermal treatment in the step 110, may enable the fabrication of three-dimensional architectures with tailored mechanical properties that may be programmed through strategic print path design and processing parameter selection.

Components formed via three-dimensional printing through the HOT-DIW process may exhibit distinctive characteristics that may result from the controlled processing of anisotropic nanostructured thermoplastic elastomers. These components may be distinguished by their ability to exhibit spatially varying mechanical properties that may be programmed through the strategic control of nanostructural alignment during the printing process. The three-dimensional printing process may enable the fabrication of components with complex architectural arrangements that may incorporate multiple regions with distinct mechanical characteristics. The resulting components may demonstrate controlled mechanical responses under applied loads, where the distribution of strain and stress may be tailored through the strategic arrangement of macro segments with different mechanical properties.

The composition of 3D printed components may be based on anisotropic nanostructured thermoplastic elastomers that may serve as the primary structural material. These thermoplastic elastomers may be characterized by multiblock copolymer architectures that may include at least one glassy block and at least one elastomeric block within their molecular structure. The glassy blocks may provide structural reinforcement through physical crosslinking mechanisms that may become active below the glass transition temperature of the glassy phase. The elastomeric blocks may contribute flexibility and elastic recovery properties that may enable the component to accommodate deformation while maintaining structural integrity. The incompatibility between the glassy and elastomeric blocks may drive microphase separation processes that may result in the formation of ordered nanostructures within the component material.

The anisotropic nanostructured thermoplastic elastomer composition may enable components to exhibit directional mechanical properties that may be controlled through the processing conditions applied during fabrication. The nanostructural alignment achieved during the printing process may influence the mechanical response of the component when loads may be applied in different directions relative to the alignment orientation. Components with nanostructures aligned parallel to applied loads may exhibit enhanced stiffness and strength compared to components with perpendicular alignment orientations. The degree of anisotropy achieved may depend on factors including the extent of nanostructural alignment, the continuity of the glassy phase domains, and the effectiveness of the thermal treatment applied following the printing process.

Components may incorporate functional additive materials within the anisotropic nanostructured thermoplastic elastomer matrix to provide enhanced functionality beyond the mechanical properties achieved through nanostructural control. These functional additive materials may include fluorescent compounds that may absorb electromagnetic radiation at specific wavelengths and emit light at different wavelengths. Phosphorescent materials may also be incorporated to provide long-lived emission properties that may continue after the excitation source has been removed. The functional additive materials may be distributed throughout the thermoplastic elastomer matrix through melt-compounding processes that may ensure uniform distribution while maintaining the processability of the material during the printing operation. The concentration and distribution of functional additives may be selected to balance the desired functional performance with the mechanical properties and structural integrity of the component.

The programmable anisotropy of 3D printed components may be achieved through the controlled application of processing conditions during the extrusion process. The alignment of nanostructures within the thermoplastic elastomer may be influenced by the shear rates, extensional strains, and draw ratios applied during the printing operation. Components may exhibit different degrees of anisotropy depending on the specific processing conditions applied during fabrication, with higher processing intensities generally resulting in greater nanostructural alignment and enhanced mechanical anisotropy. The programmable nature of the anisotropy may enable the fabrication of components with tailored mechanical properties that may be specified through the selection of appropriate processing parameters and print path strategies.

Components may be designed with at least one portion that may contain at least two macro segments arranged in various configurations to achieve controlled mechanical functionality. These macro segments may be arranged linearly in series, where adjacent segments may be positioned sequentially along the primary loading direction of the component. Alternatively, macro segments may be arranged in combinations of both series and parallel configurations, where some segments may be positioned sequentially while others may be positioned to share applied loads. The macro segments may also be arranged or oriented at angles relative to each other (e.g., one segment may be oriented at an angle (A) relative to an adjacent segment, where 0°<A<90°), creating complex load transfer pathways that may enable sophisticated mechanical responses under various loading conditions. The arrangement of macro segments may be determined by the intended mechanical functionality of the component and the specific loading conditions that the component may encounter during service.

The at least two macro segments within components may include at least one stiffer segment and at least one softer segment that may provide controlled mechanical responses under applied loads. The designation of segments as stiffer or softer may be determined by the relative mechanical properties achieved through the strategic control of nanostructural alignment during the printing process. Stiffer segments may be formed through processing conditions that may promote nanostructural alignment parallel to the intended loading direction, resulting in enhanced mechanical properties when loads may be applied along that direction. Softer segments may be formed through processing conditions that may result in nanostructural alignment perpendicular to the intended loading direction, leading to reduced mechanical stiffness when loads may be applied in that direction. The mechanical contrast between stiffer and softer segments may enable controlled strain localization within the component, where deformation may be concentrated in the softer segments while the stiffer segments may remain relatively undeformed.

Each at least one stiffer segment within components may comprise at least two layers that may be disposed in a direction parallel to a predetermined direction of tension and compression of the at least two layers. The parallel orientation of layers within stiffer segments may promote the alignment of nanostructural features along the primary loading direction, resulting in enhanced mechanical properties when loads may be applied in that direction. The formation of stiffer segments may involve the application of print paths that may orient the deposited material such that the cylindrical nanostructures within the thermoplastic elastomer may be aligned parallel to the intended loading direction. The at least two layers within each stiffer segment may be deposited with consistent orientations to maintain the mechanical property enhancement throughout the thickness of the segment. The parallel arrangement of layers may enable effective load transfer through the continuous glassy phase domains that may be aligned along the loading direction.

Each at least one softer segment within components may comprise at least two layers that may be disposed in a direction perpendicular to the predetermined direction of tension and compression of the at least two layers. The perpendicular orientation of layers within softer segments may result in nanostructural alignment that may be oriented transverse to the primary loading direction, leading to reduced mechanical stiffness when loads may be applied along that direction. The formation of softer segments may involve the application of print paths that may orient the deposited material such that the cylindrical nanostructures may be aligned perpendicular to the intended loading direction. The at least two layers within each softer segment may be deposited with consistent perpendicular orientations to maintain the reduced stiffness characteristics throughout the segment thickness. The perpendicular arrangement of layers may result in load transfer that may occur primarily through the elastomeric phase, leading to enhanced compliance and deformation capability.

The configuration of macro segments within components may enable precise tuning of mechanical functionality through the strategic control of segment arrangement, orientation, and mechanical properties. The mechanical functionality tuning may be achieved through the selection of appropriate processing parameters during the printing process, where different segments may be formed with varying degrees of nanostructural alignment to achieve the desired mechanical property contrasts. The tuning capability may enable components to exhibit controlled responses to various loading conditions, including tensile, compressive, and flexural loads applied in different directions. The mechanical functionality may be further enhanced through the application of thermal annealing processes that may optimize the nanostructural organization within each segment while maintaining the interfaces between segments that may enable effective load transfer throughout the component.

Components with tuned mechanical functionality may exhibit controlled strain localization under applied loads, where the distribution of deformation may be predetermined through the arrangement and properties of the macro segments. When loads may be applied to components with alternating stiffer and softer segments, the strain may be concentrated in the softer segments due to their reduced mechanical stiffness, while the stiffer segments may experience minimal deformation. This controlled strain localization may enable components to protect sensitive regions from excessive deformation while allowing other regions to accommodate applied loads through controlled deformation. The strain localization behavior may be tailored through the selection of segment arrangements, with series configurations providing uniform stress distribution and varying strain levels, while parallel configurations may enable load sharing according to the relative stiffness of each segment.

The mechanical functionality of components may be maintained throughout multiple loading cycles, demonstrating the stability of the nanostructural arrangements and segment configurations achieved during the printing and thermal treatment processes. Components may retain their programmed mechanical responses under repeated loading and unloading cycles, indicating that the structural modifications achieved during processing may be stable under typical operating conditions. The mechanical stability may be attributed to the physical nature of the crosslinking mechanisms within the thermoplastic elastomer, where the glassy phase domains may provide reversible load-bearing capacity without permanent structural degradation. The long-term mechanical performance may enable components to maintain their tuned functionality throughout extended service periods or under cyclic loading conditions that may be encountered in practical applications.

The HOT-DIW process may enable the fabrication of components with self-healing capabilities that may allow damaged structures to recover their programmed mechanical anisotropy through controlled thermal treatment. When components may be subjected to mechanical damage such as cuts, tears, or other forms of structural disruption, the thermoplastic nature of the elastomer matrix may enable repair through the application of thermal annealing conditions similar to those used in the post-printing treatment process. The self-healing mechanism may rely on the mobility of polymer chains within the thermoplastic elastomer when heated above the glass transition temperature of the glassy blocks, allowing severed polymer chains to re-establish connectivity across damaged interfaces. The thermal conditions applied for self-healing may promote the reformation of continuous glassy phase domains that may restore the mechanical properties and anisotropic behavior of the original component.

The self-healing process may involve heating damaged components to temperatures that may provide adequate molecular mobility for polymer chain diffusion while avoiding thermal degradation of the material. In some cases, the self-healing treatment may be performed at temperatures ranging from approximately 140° C. to 160° C. for periods that may extend from several minutes to several hours depending on the extent of damage and the desired degree of property recovery. The effectiveness of the self-healing process may depend on factors including the nature and extent of the damage, the molecular architecture of the thermoplastic elastomer, and the thermal conditions applied during the healing treatment. Components that may undergo successful self-healing may exhibit mechanical properties and anisotropic behavior that may closely match those of the original undamaged structure, demonstrating the reversible nature of the physical crosslinking mechanisms within the thermoplastic elastomer matrix.

The multi-cycle reprocessing capabilities of components fabricated through the HOT-DIW process may enable repeated recycling and reforming operations without substantial degradation of the achievable anisotropy or mechanical properties. The thermoplastic nature of the elastomer matrix may allow components to be remelted and reprocessed through multiple cycles, where the material may be collected, reheated, and reformed into new components with similar performance characteristics. The reprocessing capability may result from the absence of permanent chemical crosslinks within the thermoplastic elastomer, allowing the material to be repeatedly cycled between solid and melt states without irreversible structural changes. The molecular architecture of the multiblock copolymer may remain intact throughout multiple reprocessing cycles, enabling the reformed components to exhibit nanostructural organization and mechanical anisotropy comparable to components fabricated from virgin material.

The reprocessing operations may involve heating used components to temperatures above the glass transition temperature of the glassy blocks to enable material flow and reformation. The remelted material may be subjected to the same processing conditions used for virgin material, including controlled shear rates, extensional strains, and draw ratios during the extrusion process. The reformed components may undergo thermal annealing treatments similar to those applied to components fabricated from virgin material, enabling the development of enhanced nanostructural organization and mechanical anisotropy. The multi-cycle reprocessing capability may provide environmental and economic advantages by enabling the recovery and reuse of thermoplastic elastomer material from end-of-life components, reducing waste generation and material consumption in manufacturing operations.

The HOT-DIW process may enable the fabrication of components with complex geometric structures that may demonstrate the versatility and capability of the manufacturing approach. These complex geometries may include log-pile structures that may consist of alternating layers of parallel filaments arranged in perpendicular orientations to create three-dimensional lattice architectures. The log-pile structures may demonstrate the ability of the process to create spanning elements that may bridge gaps without intermediate support, indicating the structural integrity that may be achieved through proper control of processing parameters and material properties. The spanning capability may result from the rheological properties of the thermoplastic elastomer at processing temperatures, where the material may exhibit adequate yield stress to maintain structural geometry during deposition while possessing flow characteristics that may enable smooth extrusion through the nozzle.

High aspect ratio structures such as vases may demonstrate the capability of the process to create tall, slender geometries through the successive deposition of multiple layers without structural collapse or dimensional distortion. These high aspect ratio vases may involve the deposition of dozens of layers in vertical arrangements, where each layer may be supported by the underlying structure while contributing to the overall geometric complexity of the component. The successful fabrication of high aspect ratio structures may indicate that the thermoplastic elastomer material may possess adequate structural stability at processing temperatures to support the weight of successive layers while maintaining dimensional accuracy throughout the printing process. The thermal management during the fabrication of high aspect ratio structures may involve coordination between the nozzle temperature, substrate temperature, and ambient cooling conditions to achieve proper interlayer bonding while preventing structural deformation.

Spanning structures may represent another category of complex geometries that may be achieved through the HOT-DIW process, where portions of the component may extend across open spaces without underlying support material. These spanning structures may demonstrate the ability of the extruded filament to maintain structural integrity over distances that may exceed multiple times the filament diameter, indicating the effectiveness of the processing conditions in achieving adequate material properties for unsupported deposition. The spanning capability may be influenced by factors including the draw ratio applied during extrusion, the cooling rate of the deposited material, and the rheological properties of the thermoplastic elastomer at the deposition temperature. The successful creation of spanning structures may enable the fabrication of components with internal cavities, overhanging features, and complex three-dimensional architectures that may not be achievable through conventional manufacturing processes.

Unsupported overhangs may represent additional geometric complexity that may be achieved through the controlled application of processing parameters during the HOT-DIW process. These overhanging features may extend outward from the main body of the component at angles that may challenge the structural stability of the deposited material during the printing process. The successful fabrication of unsupported overhangs may depend on the balance between material flow properties during extrusion and solidification characteristics following deposition. The processing conditions may be adjusted to achieve adequate material viscosity and yield stress to prevent sagging or deformation of overhanging features while maintaining smooth flow through the extrusion nozzle. The geometric limitations for unsupported overhangs may be determined by factors including the overhang angle, the length of the unsupported span, and the thermal conditions during deposition.

The advanced capabilities demonstrated through complex geometric structures may enable applications in specialized fields where conventional manufacturing approaches may face limitations. The combination of controlled mechanical anisotropy, self-healing behavior, and geometric complexity may make components fabricated through the HOT-DIW process suitable for applications in wearable devices where conformability, durability, and repairability may be desired characteristics. The ability to create components with spatially varying mechanical properties may enable the design of wearable devices that may provide controlled mechanical responses in different regions, such as enhanced flexibility in areas requiring conformability and increased stiffness in areas requiring structural support.

Soft robotics applications may benefit from the controlled mechanical anisotropy and self-healing capabilities that may be achieved through the HOT-DIW process. Robotic components that may be subjected to repeated mechanical stresses or occasional damage may utilize the self-healing properties to maintain functionality throughout extended service periods. The ability to program mechanical anisotropy may enable the creation of robotic elements with directional mechanical responses that may be tailored for specific actuation or sensing functions. The complex geometric capabilities may enable the fabrication of robotic components with intricate internal structures that may provide enhanced functionality compared to components fabricated through conventional manufacturing processes.

The reprocessing and recycling capabilities may enable sustainable manufacturing approaches for applications where component replacement or modification may be required throughout the service life of a system. The ability to recover and reuse thermoplastic elastomer material may reduce the environmental impact of manufacturing operations while providing economic advantages through material cost reduction. The maintained performance characteristics throughout multiple reprocessing cycles may enable the creation of circular manufacturing systems where end-of-life components may be collected, reprocessed, and reformed into new components with comparable performance characteristics. These sustainable manufacturing capabilities may be particularly valuable for applications in consumer electronics, automotive components, and other fields where product lifecycles and environmental considerations may influence material selection and manufacturing approaches.

### Example 1—Effect of Forces Due to Flow within the Nozzle on Resulting Structure

First, we probe the effect of forces due to flow within the nozzle (see FIG. 2) on the resulting TPE nanostructure alignment. To quantify the effects of flow within the nozzle, the Rabinowitz corrected shear rate is calculated, which describes flow of a shear-thinning fluid through a cylindrical capillary (Equation 1) as a measure of the maximum shear rate experienced by material inside the nozzle.

$${\dot{γ}}_{max} = \frac{3 n + 1}{4 n} \frac{4 Q}{π {R}_{nozzle}^{3}} \qquad ( 1 )$$

This quantity depends on the volumetric flow rate Q, nozzle exit radius R_{nozzle}, and a power law shear-thinning exponent n, which was obtained as 0.81 from fitting to rheological data. While Equation 1 is only rigorous in the case of fully developed flow within the cylindrical capillary, the calculated \dot{γ}ₘₐₓ remains a helpful (but not strictly quantitative) quantity to parameterize the flow. Here, \dot{γ}ₘₐₓ is primarily controlled by varying both Q and R_{nozzle}. Although the effects of the flow within the nozzle were quantified using a measure of the shear rate, it is critical to note that the extrudate experiences a complex flow profile with a significant extensional component within the nozzle, particularly along the centerline and in the converging region. Thus, as the volumetric flow rate increases, the magnitude of shear and extensional flow rates within the nozzle increase in tandem. As such, \dot{γ}ₘₐₓ should be taken as a proxy for the coupled shear and extensional flows within the nozzle, since both components of the flow will be strongly impacted by both Q and R_{nozzle}.

In order to quantify the effects of these 3DP processing flows, two primary techniques are used to quantify the structural and mechanical anisotropy that result from 3DP of single TPE filaments. First, 2D small-angle X-ray scattering (2D-SAXS) collected with x-ray bea perpendicular to the filament axis probes the extent of alignment of cylindrical nanostructures along the filament axis. From these data, an orientational order parameter <P₂> is extracted as a convenient measure of the overall extent of unidirectional alignment of the TPE nanostructures within 3D printed filaments, calculated from the angular (χ) distribution of scattering intensity (Equation 2).

$$〈 {P}_{2} 〉 = \frac{3 〈 {cos}^{2} χ 〉 - 1}{2} \qquad ( 2 )$$

This orientational order parameter has an embedded assumption that the object possesses cylindrical symmetry; here, this assumption is reasonable due to the uniaxial symmetry of the flow profile within the nozzle. Note that <P₂> is calculated from the primary SAXS peak, which corresponds to lateral cylinder-cylinder correlations.

Secondly, tensile testing probes the extent of both nanostructure alignment and glassy PS domain continuity within printed filaments. To quantify mechanical anisotropy isolated from print path effects, the small-strain modulus of single printed filaments measured along the print direction, E_{∥}, are reported. Tensile testing performed on sheets of printed material yield E over a narrow range between 1.2-2.2 MPa with no systematic dependence on printing conditions. Therefore, while the single filament geometry is not conducive to tensile measurements perpendicular to the print path (and thus this example does not report E_{⊥}/E_{∥} directly for single filaments), the data supports that En is an appropriate proxy for the mechanical anisotropy of a sample. It is critical to emphasize that the modulus of an oriented sample is dependent on both PS domain alignment and long-range PS domain continuity. Beyond a certain limit, X-ray scattering is not informative concerning the latter. While the full-width at half maximum (FWHM) of X-ray scattering can be informative regarding domain size in the cylinder-cylinder correlation direction, the measurement provides no information regarding domain size along the cylinder axis; it is this latter size that dominates the tensile mechanics of the disclosed materials. As such, X-ray scattering and small-strain tensile testing probe distinct and complementary aspects of aligned 3D printed samples.

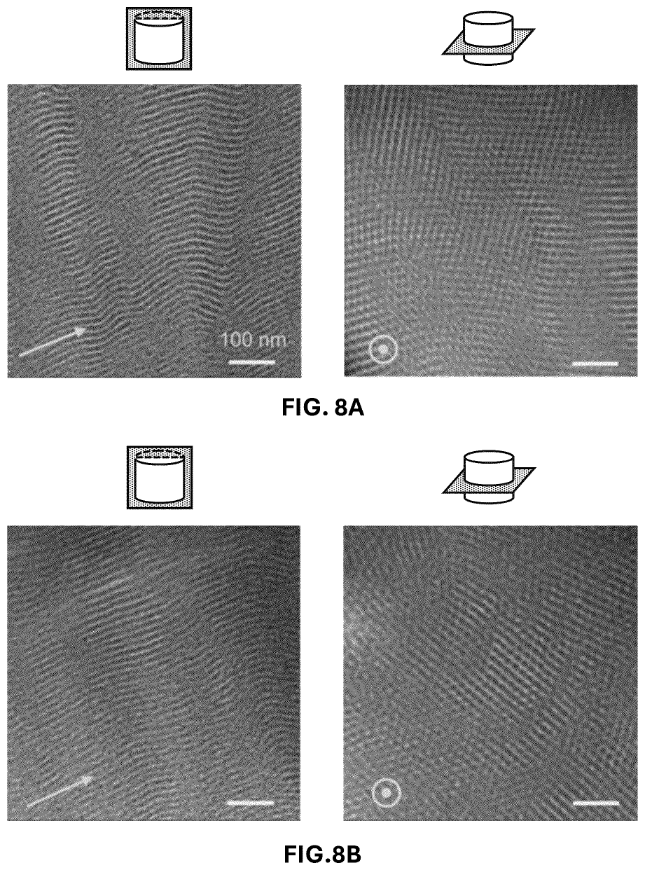

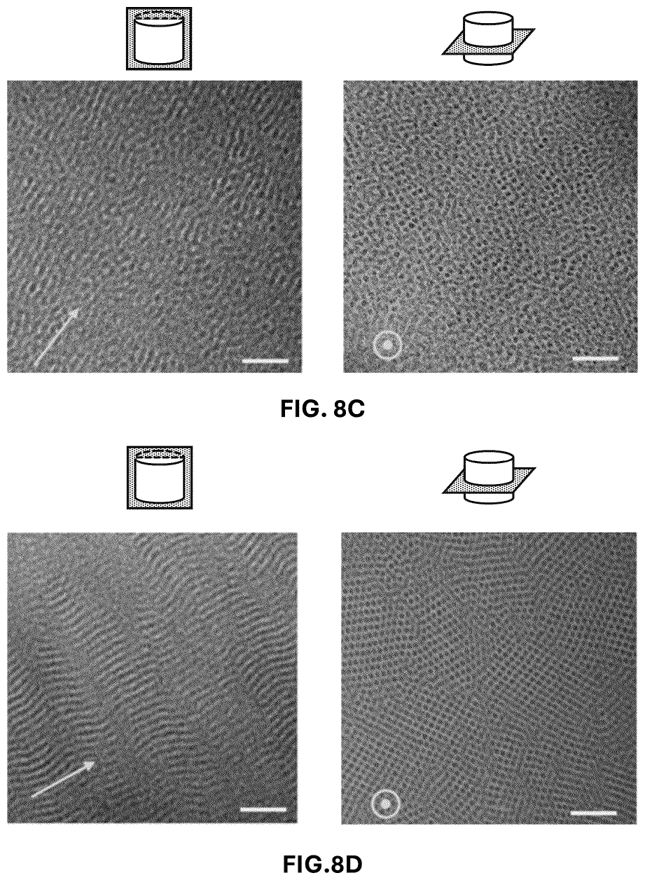

With these characterization methods, it was found that samples printed with increasing \dot{γ}ₘₐₓ exhibit a decrease in measures of both structural (FIG. 7A) and mechanical (FIG. 7B) anisotropy upon 3D printing. Alone these results may suggest a decrease in the extent of alignment induced by such printing conditions. However, it was found that for all samples printed at or above a critical shear rate \dot{γ}_{c}˜1 s⁻¹, thermal annealing at 150° C. for 10 minutes after 3D printing results in a significant increase in measures of both structural and mechanical anisotropy. Annealed samples display <P₂> and E_{∥} ranging between 0.75-0.92 and 50-100 MPa respectively. The nature of this increase in anisotropy is intriguing, since thermal annealing does not itself provide a driving force to induce alignment. As such, the increase in anisotropy observed upon annealing must result from structural rearrangements and/or relaxations of trapped stresses in an aligned but defect-heavy nanostructure. This is supported by TEM imaging of high \dot{γ}ₘₐₓ samples before and after thermal annealing (see FIGS. 8C, 8D). Before annealing we observe a clear lack of long range domain continuity and nanostructure ordering, whereas after thermal annealing we observe a high degree of long-range PS domain continuity and a highly regular ordered nanostructure. This is additionally supported by the decrease in the FWHM of the primary SAXS peak of high \dot{γ}ₘₐₓ samples upon thermal annealing (FIG. 7C).

A deviation from the previously discussed behavior was observed in the lowest range of shear rates probed in this example. Samples printed below \dot{γ}_{c} exhibit no significant change in either structural or mechanical anisotropy upon annealing, and SAXS analysis reveals decreases in domain spacing but no significant change to the FWHM upon thermal annealing. These features in the SAXS patterns indicate that thermally annealing these samples leads to a relaxation of a deformed but well-ordered nanostructure. This is in contrast with samples printed well above the \dot{γ}_{c} transition, which exhibit no change in domain spacing upon thermal annealing. Samples printed below this transition also exhibit a significantly lower degree of mechanical anisotropy after annealing (E_{∥}=25.5 MPa), compared to samples printed above \dot{γ}_{c} (E_{∥}>50 MPa). This drastic difference in E_{∥} despite effectively identical <P₂> indicates that the nanostructure is similarly aligned along the print path, but even after thermal annealing lacks the long-range PS domain continuity required to display similarly increased moduli. TEM imaging of these samples both before and after thermal annealing confirms the presence of well-defined hexagonal ordering of PS cylinders both before and after annealing, with minimal observable changes upon annealing. See FIGS. 8A, 8B. Unfortunately, the characterization approaches used for this example were incapable of directly probing the critical PS cylinder length which is necessary to achieve outstanding tensile moduli.

The presence of this transition in anisotropy and response to thermal annealing suggests the presence of a critical shear rate and/or extensional strain rate associated with this \dot{γ}_{c} threshold, above which a critical chain and/or nanostructure relaxation is unable to occur on the timescale of 3D printing. Based on the structural and mechanical anisotropy observed in printed and annealed samples, this relaxation upon thermal annealing must lead to a greater degree of long-range PS cylinder continuity and therefore a reduction in the number of mechanically ineffective defects in samples printed above this \dot{γ}_{c} threshold.

### Example 2—Effect of Extensional Flow By Filament Drawing

Next, the impacts of nearly isolated extensional flow by filament drawing during deposition are examined. By translating the nozzle at a velocity greater than the average material velocity, one can obtain “highly drawn” filaments with cross-sectional areas smaller than that of the nozzle. The magnitude of this extensional flow can be quantified via the ratio of nozzle translation and average material velocities, or of the cross-sectional areas of the nozzle, A_{nozzle}, and the deposited filament, A_{filament} (Equation 3). Experimentally, this is achieved by extruding at a fixed volumetric flow rate and increasing the translational velocity from v₀, which produces a filament equal in diameter to the nozzle, to v_{nozzle}, which produces a filament smaller in diameter than the nozzle.

$${D}_{R} = \frac{{A}_{nozzle}}{{A}_{filament}} = \frac{{v}_{nozzle}}{{v}_{0}} at fixed Q \qquad ( 3 )$$

This form of applied extension imparts nearly uniform extensional flow across the entire deposited filament, and varying the draw ratio adjusts the effective strain rate and net extensional strain experienced by the entire filament diameter prior to deposition. This is in contrast with other sources of extensional flow in 3DP where the extension is highly localized, such as the extensional flow within the nozzle centerline, or the extensional flow associated with the 90° turn during material extrusion printing which is concentrated in the lower region of a deposited filament.

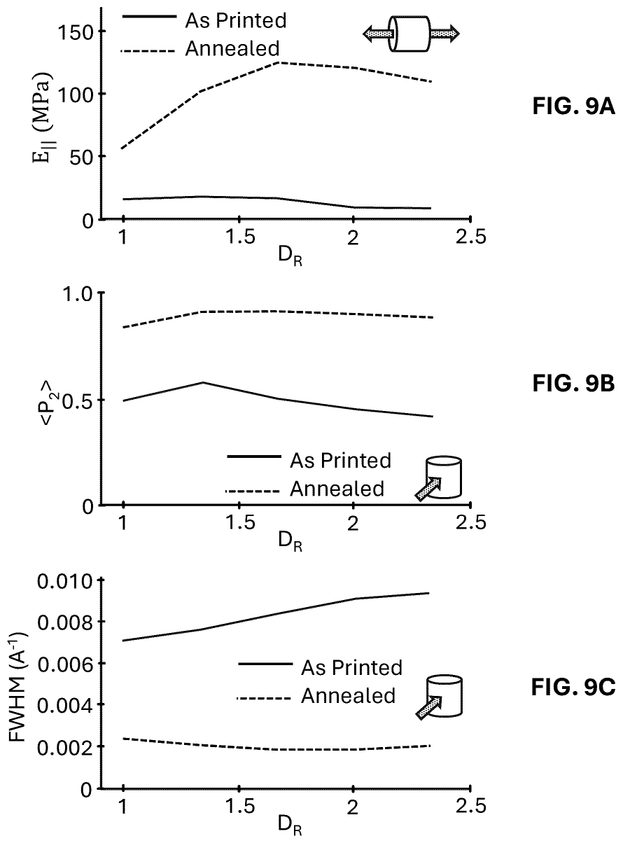

It was found that applying this nearly pure extensional flow (see FIG. 9A) by increasing the draw ratio provides the most effective means of achieving a high degree of mechanical anisotropy in 3D printed TPEs. Samples printed with D_{R}>1 (with a fixed \dot{γ}ₘₐₓ=90 s⁻¹, chosen to facilitate rapid sample fabrication) display little effect of D_{R} on anisotropy immediately upon printing, but recover very high values of structural (see FIG. 9C) and mechanical (see FIG. 9B) anisotropy upon thermal annealing, with <P₂>˜0.90 and E_{∥}>100 MPa. Similar to the un-drawn samples printed at this \dot{γ}ₘₐₓ, these high D_{R} samples also display a significant decrease in FWHM of the primary scattering peak observed via SAXS (FIG. 4d). Similar trends in <P₂> and FWHM with respect to D_{R} are observed for a series printed at a moderate \dot{γ}ₘₐₓ (2.7 s⁻¹) which is only slightly above the \dot{γ}_{c} threshold.

There are several potential causes for the increase in alignment upon annealing observed in samples printed at high draw ratios (D_{R}>1). The increased structural and mechanical anisotropy observed in annealed high D_{R} samples may be attributable to the fact that the extensional forces applied to the material via ‘drawing’ are distributed across the entire cross-sectional area of the filament. This is in contrast with the extensional flow inside the nozzle, which is expected to be spatially varied and concentrated along the centerline of the nozzle. It is possible that extensional flow is the dominant factor in inducing a high degree of structural and mechanical anisotropy across all samples in this work, and the increased anisotropy observed in high D_{R} samples is reflective of the higher proportion of extension in the material flow history. Another notable difference between the in-nozzle and post-extrusion extensional flows is the temperature at which the extensional flow occurs. Extension occurring within the 3DP nozzle is occurring at or near the measured nozzle temperature of 160° C. which is well above the PS block T_{g}, while the extension applied by drawing is occurring as the material is rapidly cooling down upon exposure to a near-T_{g} substrate and the surrounding ambient air. The limited PS chain mobility associated with the proximity to the glass transition during this extensional flow may account for a greater magnitude of unrelaxed stresses being trapped in the extrudate upon 3D printing, resulting in a more significant nanostructural rearrangement towards a higher population of long-range continuous PS cylinders upon thermal annealing.

The increased mechanical anisotropy induced by annealing highly drawn filaments is accompanied by additional nanostructural changes upon annealing. SAXS analysis of the D_{R} series at both high (90 s⁻¹) and moderate (2.7 s⁻¹) \dot{γ}ₘₐₓ reveals trends similar to those observed in high \dot{γ}ₘₐₓ samples without drawing: the primary scattering peak does not shift upon annealing while the FWHM decreases, corresponding to a transition from an aligned but highly defect-heavy nanostructure to a well-oriented nanostructure comprised of high aspect ratio PS cylinders. It was noted that all highly drawn samples exhibit a slight decrease in the post-annealing domain spacing compared to the un-drawn (D_{R}=1) samples, which is consistent with findings previously reported for how cylindrical SEBS nanostructures relax after being exposed to uniaxial extension in the melt state.

### Example 3—3D Printing Samples

In order to effectively leverage these anisotropic properties in printed architectures, we must ensure that the material is compatible with printing well-defined, controlled structures. In order for a material to be 3D printable using extrusion-based techniques, it must meet several rheological criteria. These criteria include shear-thinning behavior to facilitate flow within the nozzle, while a higher effective viscosity and/or the presence of a sufficient yield stress allows for the material to effectively solidify upon deposition to preserve the intended structure and physically support additional layers without deforming. When 3DP inks do not possess a true yield stress they are poorly suited to generate spanning structures, unsupported overhangs, or supporting many layers without sagging. Melt-extrusion of TPEs, specifically onto a near-T_{g} substrate, meets these rheological requirements very well due to the shear-thinning behavior observed in the melt state as well as the presence of a true yield stress resulting from the microphase separated nanostructure geometry. These rheological features are characteristic of materials that are well-suited to melt-extrusion 3D printing.

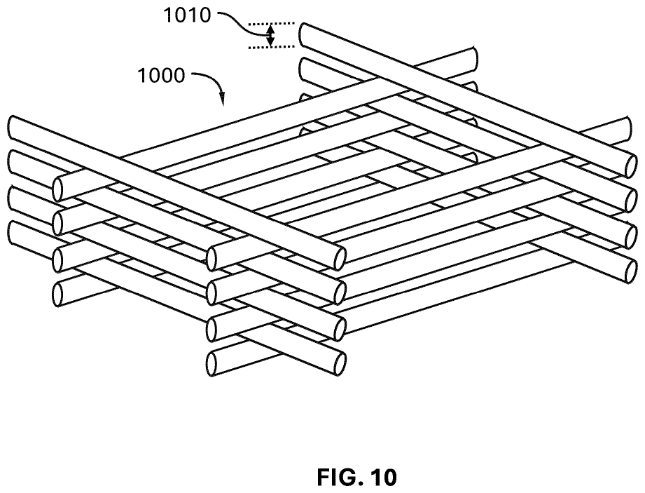

The disclosed material and approach is ideal for 3DP through its ability to achieve several representative ‘challenging’ structures. In a classic log-pile structure, a small portion of such being shown in FIG. 10, minimal sagging of spanning structures (1000) was observed, indicating that these 3DP SEBS filaments can effectively span gaps of 10× the filament diameter (1010).

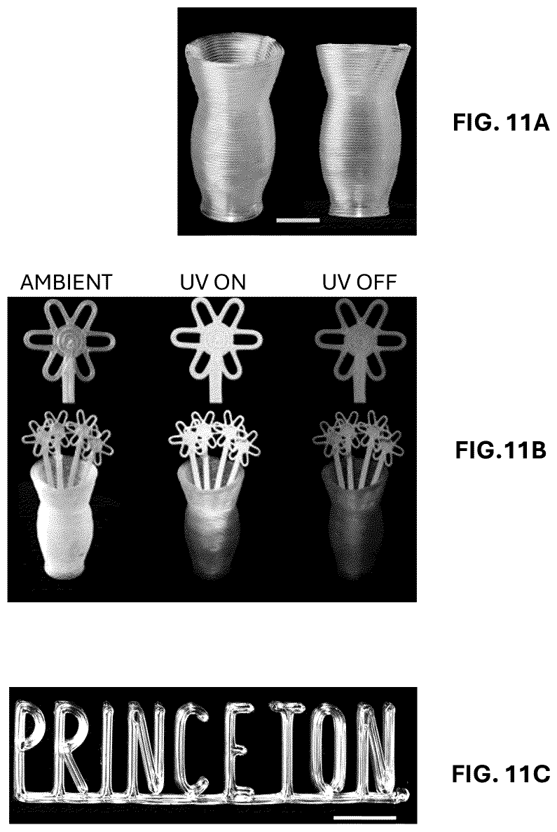

A high aspect ratio vase was fabricated (FIG. 11A) to demonstrate the ability to print many (60+) layers without any significant sagging, and to demonstrate the material's ability to accommodate printing moderate overhangs of unsupported material.

Additionally, the ability to easily incorporate functional additive materials into the 3DP ink, such as perdeuterated contorted hexabenzocoronene (d₂₄-cHBC), an organic molecule which exhibits long-lived (>20 s) red phosphorescence upon relaxation following UV-excitation, was showcased. Flower shapes from the yellow-colored 0.5 wt % d₂₄-cHBC in SEBS composite and show that the emission properties are maintained in the 3DP composite (FIG. 11B).

As shown in FIG. 11C, high print path fidelity through multiple layers in more complex geometric print paths including sharp turns via fabrication of a well-resolved multi-layer text object can be seen.

Additionally, the presence of a yield stress in these triblock thermoplastic elastomers in the melt uniquely facilitates thermal annealing to both improve interface quality and increase mechanical anisotropy without deformation or loss of resolution in the 3D printed structure. Traditional 3D printed structures frequently suffer from poor interfacial mechanics due to the incompatibility of traditional thermoplastics such as ABS and PLA with such a post-printing thermal annealing step. Without such a processing step to allow for adequate polymer chain diffusion and formation of entanglements across filament interfaces, there are few simple methods to improve the mechanics of 3D printed parts. The ability to thermally anneal these TPEs above T_{g} to improve the interfacial properties of 3D printed architectures without any loss of programmed structure or function is a distinct advantage of this class of materials.

### Example 4

Next the ability to control material properties along a print path is demonstrated, enabling fabrication of soft architectures tailored to exhibit controlled mechanical functionality such as controlled localization of tensile and flexural deformation. Several representative mechanically functional architectures are fabricated using the fixed \dot{γ}ₘₐₓ=90 s⁻¹ and D_{R}=1.67 printing condition. Here a single printing condition is used because it is straightforward to encode when manually designing print paths, though the printing condition can additionally be varied throughout an architecture to provide an additional level of tunability beyond solely customizing the print path.

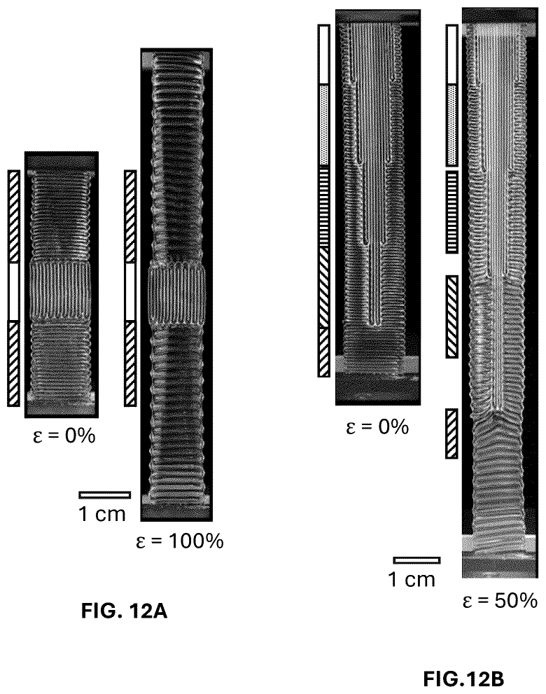

It is demonstrated that tensile strain isolation to a particular region of a printed object can be programmed by organizing stiff and soft segments of a strip in series (see FIGS. 5, 12A), or a combination of segments both in series and in parallel (see FIGS. 6, 12B). When strain is applied along the intended direction, the engineering stress is uniform across the length of the strip, but strain concentrates in the soft segments due to the lower modulus. For samples organized fully in series, stiff segments retain their original dimensions (straining less than 2%) until the soft segments achieve approximately 225% strain. When soft segments experience this strain, the engineering stress reaches the yield stress of the stiff segment, or 1.15 MPa, and more significant deformation of the stiff segment is induced. Segments organized both in series and in parallel configurations exhibit a combination of this yielding behavior and distribution of tensile deformation according to the effective modulus of each segment. This sample geometry results in stiffer segments remaining below their yield stress for a much greater range of overall applied strains.

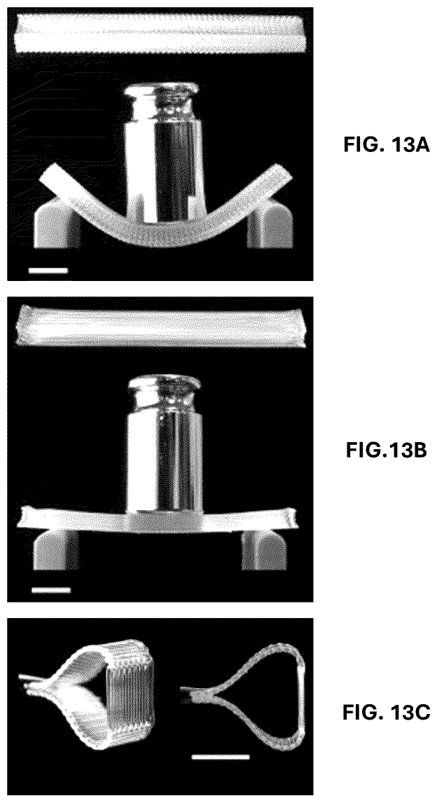

In addition to programmable behavior in response to tensile strain, these architectures also exhibit highly anisotropic flexural behavior (FIGS. 13A and 13B). Bending moduli of 2.48 and 1.07 MPa were measured via single-cantilever DMA measurements for samples fabricated with the print direction along (13A) and perpendicular to (13B) the long axis of the test specimen, respectively. This flexural anisotropy can be leveraged to localize bending in these types of soft architectures (see FIG. 13C). While 3DP samples display some of this mechanical anisotropy before thermal annealing, the extent of tensile and flexural strain isolation is greatly enhanced by thermal annealing and is therefore a critically important processing step in fabricating these functional soft architectures. Ultimately, it is envisioned that these strain isolation capabilities can be leveraged for applications such as housing delicate components and electronics in strain-isolated regions of wearable devices.

### Example 5

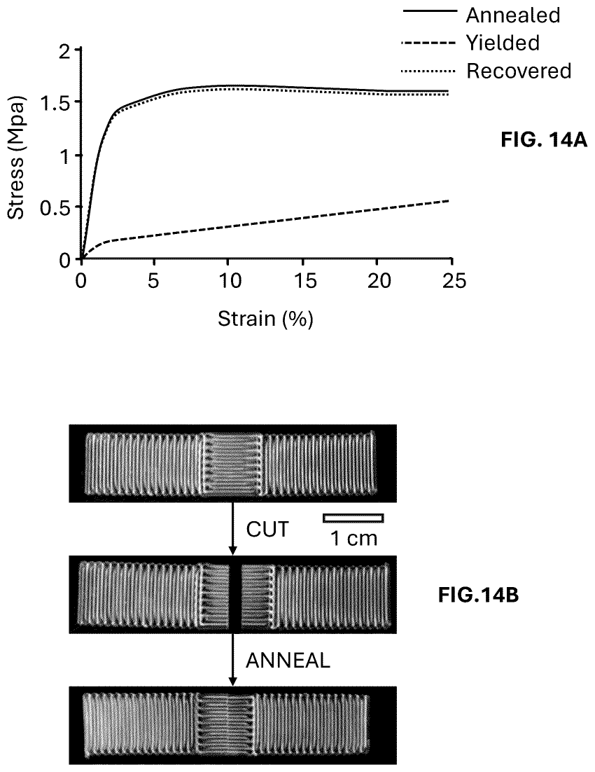

Finally, the ability to maintain the programmed mechanical function for multiple cycles is demonstrated, even after straining beyond the point of softening due to PS cylinder breakup. As previously discussed, the stiffness of an oriented styrenic TPE is governed by both PS domain alignment and long-range continuity. As such, an appropriately oriented sample may exhibit a high small strain modulus (E_{∥}>Eᵢₛₒ=3.2 MPa) in the direction of alignment before yielding on the first strain cycle, but will exhibit a low small strain modulus (approx.=Eᵢₛₒ) on all subsequent straining cycles. However, straining to a point between yielding (ε˜2%) and fracture (ε˜1000%) results in breakup of PS cylinders without permanent disruption of the alignment of the PS domain segments after the strain is released. Thermal annealing of these yielded 3D printed samples allows sufficient mobility of PS chains to weld the interfaces between broken PS domains to recover long range domain continuity and the associated first-cycle mechanical properties. This recovery of properties has been previously demonstrated in bulk oriented TPE samples, and allows one to easily recover the programmed mechanical function after cylinder-breakup due to straining in our 3D printed soft architectures. No significant difference between the modulus of an annealed sample and of a sample which has been ‘damaged’ via straining beyond yielding and then ‘recovered’ by thermal annealing at the same thermal conditions described previously was observed. See FIG. 14A.

Additionally, 3D printed TPEs that have been broken or cut can self-heal upon a brief thermal anneal. TPEs have previously been demonstrated as a source of self-healing behavior in soft robots. Here we demonstrate that when our 3D printed TPEs are cut and self-healed via a brief thermal annealing step (10 min. at 150° C.), the initially programmed mechanical anisotropy is maintained in the healed object. See FIG. 14B. This thermal annealing provides sufficient mobility for PS cylinders to regain domain connectivity across the cut interface, ultimately recovering the long-range PS domain continuity required for improved stiffness along the programmed direction of alignment.

A further intrinsic advantage of these thermoplastic elastomers for 3D printing is the inherent melt reprocessability and recyclability. Traditional elastomers are chemically crosslinked, and therefore are not recyclable. Significant effort in recent years has gone into developing chemically recyclable elastomer networks and resins for 3D printing applications. However, these methods are frequently expensive, synthetically challenging, and/or exhibit considerable degradation of properties upon recycling. In contrast, thermoplastic elastomers offer multi-cycle melt reprocessability and reprogrammability without loss of achievable anisotropy, as well as the previously discussed self-healing behavior. These benefits are inherent to nanostructured thermoplastic elastomers without any additional chemical functionalization or complex processing steps, making these materials prime candidates for many scalable applications of interest.

In some of the above examples disclosed herein, the triblock copolymer, KRATON® MD1648 block copolymer, was provided in the form of dense pellets and was used as received. Gel permeation chromatography (GPC) was run on a PSS SDV analytical 1000 Å column with a THE flow rate of 0.3 mL/min, using a refractive index detector. GPC analysis provided Mₙ=43.6 kg mol⁻¹ and Ð=1.02 with respect to PS standards. The styrene content was determined to be 19.4 wt % according to 1H-NMR analysis. NMR was performed in a 500 MHz Bruker spectrometer with a 10 second relaxation delay. Differential scanning calorimetry, run from −80 to 150° C. at 2° C. min⁻¹ on a TA-DSC2500 indicated glass transition temperatures of −45° C. and approximately 62° C. for PEB and PS blocks respectively. Small-angle X-ray scattering of a sample slowly cooled from above T_{ODT} indicates the equilibrium nanostructure takes the form of a hexagonal lattice of cylinders with an equilibrium domain spacing of 20 nm between {10} planes (d₁₀=20 nm) as received, and remains hexagonal at all processing conditions used in this work. Globally isotropic control samples of approximately 0.5 mm thickness for mechanical analysis and for rheological studies were prepared by cooling SEBS from above T_{ODT} using a Carver hot press. Rheological characterization performed on an Anton Paar MCR 302e using a 25 mm parallel plate configuration with a gap height of 0.385 mm. A steady shear-rate sweep from 0.01-100 s⁻¹ yielded a shear thinning exponent n=0.81. Oscillatory strain amplitude sweeps from 0.1-10% at a fixed frequency ω=0.03 rad s⁻¹ allowed for characterization of the yield-stress behavior at the extrusion temperature.

3D printing was carried out using a custom heated volumetric extruder. A 50 mL capacity stainless steel reservoir with 20 mm inner diameter was mounted in a custom machined aluminum block fitted with two 300 W (91 W in⁻²) heating cartridges (McMaster). Temperature control was achieved using a PID controller (Inkbird 106VH) and a k-type M3 screw thermocouple (uxcell) fitted adjacent to the nozzle. The nozzle temperature was set to 160° C. to facilitate extrusion of a smooth filament and avoid melt-flow instabilities at targeted extrusion rates. The nozzle temperature was allowed to stabilize to within 1° C. for at least 15 minutes before use. Temperature fluctuations during printing were minimal (<1° C.). Volumetric extrusion was controlled by activating a NEMA 17 stepper motor (StepperOnline) to drive a lead-screw-mounted custom-machined stainless-steel plunger fitted with a rigid Teflon O-ring (McMaster) through the reservoir. Custom M6 threaded Arque style nozzles (Tecdia) with 250 and 700 μm inner diameters were fitted to the end of the reservoir for extrusion.

The extruder assembly was mounted to a set of controlled motion axes (Aerotech). Communications with the stepper motor and all motion axes were controlled through the instrument software (Aerotech A3200). Samples were 3D printed onto 1 mm×25 mm×75 mm microscope slides (VWR) or ⅛″ borosilicate glass substrates (McMaster) as dictated by overall sample dimensions. Glass printing substrates were secured on a leveled low-profile hot plate (Wenesco) set to 90° C. The actual substrate temperature was 85° C., as verified by IR thermometer and k-type thermocouple readings. This substrate temperature was chosen as the minimum temperature required which allows sufficient sample adhesion during and following turns.

Select low shear rate samples requiring extremely long (>6 hour) print times were fabricated using a HYREL® Engine SR Standard Resolution 3D printer equipped with a TAM head and HTK-270 high temperature, high torque compatible reservoir. The reservoir was fitted with the previously described custom TECDIA® nozzles for extrusion, and had a capacity of approximately 2 mL. Reservoir and print bed temperatures were calibrated such that the nozzle and substrate temperatures were within 2° C. of the previously described 3D printer assembly. G-code commands run on this instrument were written manually such that all translational speeds and material extrusion rates were identical to parameters used on the Aerotech system.

For the red-light emitting SEBS/d₂₄-cHBC 3D printed flowers, SEBS pellets were melt-compounded with 0.5 wt % perdeuterated contorted hexabenzocoronene powder. This was done by melt-pressing the two components between Teflon sheets at 150° C., manually compressing the resulting sheet into a ball, and melt-pressing again a total of 8 times to ensure homogeneity. The mixture was 3D printed using \dot{γ}ₘₐₓ=27 s⁻¹ and D_{R}=1 as printing conditions, additionally using PVA coated glass slides as substrates to improve adhesion. 3D printing was performed using the HYREL reservoir custom-mounted on the Aerotech axes and controlled similarly to the fully custom extruder.

3D printing nozzle velocities and volumetric extrusion rates were varied from 0.0075-18 mm s⁻¹ and 0.00289-2.89 mm³ s⁻¹ in order to achieve the desired draw ratio (D_{R}) and maximum shear rate \dot{γ}ₘₐₓ (Equations 1, 3). Generalized print path parameters were determined as a function of a theoretical filament diameter (D_{fil,theo}) assuming deposition of a perfectly cylindrical filament. Layer heights were calculated using H=\sqrt{π/4}*D_{fil,theo}, determined experimentally in order to achieve excellent substrate adhesion. Interfilament separation distances (II) were determined experimentally using IF=1.075*D_{fil,theo}. If this spacing between filaments is too large, poor interfilament adhesion results in premature delamination during handling and/or straining. In contrast, if the spacing is too small, the unidirectional nanostructural alignment is disrupted, resulting in significant deviation from the intended programmed material properties. By defining these key print parameters as functions of the programmed filament diameter, they are generalizable and consistent across the range of nozzle sizes and draw ratios accessed in this study.

3D printed samples were annealed on a hot plate set to 150° C. for 10 min with a constant flow of N₂ to prevent oxidative degradation. During annealing, samples were arranged on ⅛″ glass sheets coated with a thin layer of silicone oil (Beantown chemical) to prevent the samples from adhering to the glass. Multi-layered samples were annealed in a 150° C. oven for 1 hr, and did not exhibit detrimental shape distortion.

Small angle X-ray scattering was performed under vacuum at the 12-ID beamline at Brookhaven National Laboratory using a micro-focused (2 μm×25 μm) 14.5 keV X-ray beam using 0.5 s collection times. Line profile scans were performed across individual printed filaments in a ‘top-down’ orientation with a scan spacing of 5 μm. For the analysis presented in this work, all scans collected for each sample were summed to produce a single scattering pattern representing the average sample properties. Data processing was performed using custom Python scripts and the SMI beamline package. Background subtraction was performed to account for instrumental and environmental background. Orientational order parameters <P₂> were calculated for each sample using the azimuthal scattering intensity profile for the primary scattering peak (0.025-0.04 Å⁻¹). All values extracted from SAXS analyses represent the average and standard deviation taken from 3 replicate samples. Additional SAXS experiments included in the SI were performed on a Xeuss 3.0 with a Dectris Euger 2R IM detector using a 1750 mm SDD and a Cu Kα (1.54 Å⁻¹) source using the high-resolution collimation setting and line-eraser mode. Azimuthal and radial intensity profiles were extracted using the XSACT software and were analyzed further using the same scripts as above.

To prepare samples for transmission electron microscopy (TEM) characterization, the 3DP filaments of interest were first sputter coated with a thin (ca. 10 nm) iridium layer to improve visibility during embedding and microtoming. Next, the samples were embedded in the desired orientation in a rigid fixative (EPOXICURE® 2 Resin & Hardener) for mechanical support during slicing. After the epoxy was fully cured (24+ hrs), block faces were shaped using double-edged razors to expose the desired area of the filament, followed by collections of 40 nm (side-on orientation) or 80 nm (end-on orientation) cross-sections via cryo-ultramicrotomy (Leica Ultracut UCT Ultramicrotome) at a sample temperature of −65° C. with a −60° C. diamond knife temperature. The cut specimens were dry-lifted and transferred to TEM grids (300 mesh, with amorphous carbon layer). To provide electron contrast during imaging, preferential ruthenium tetroxide (RuO₄) staining of polystyrene domains was performed using a custom-made poly(methyl methacrylate) (PMMA) vapor chamber following previously published procedures. Vapor-phase ruthenium tetroxide was generated from an aqueous solution by combining 10 mL DI water, 15 mg ruthenium dioxide, and 250 mg sodium meta-periodate. Vapor was allowed to accumulate within the chamber for ca. 5 minutes prior to sample addition. Based on a time series ranging from 5-60 minutes, 15 minutes of exposure was found to provide optimal staining conditions and was used for all imaging. Upon removal of the TEM samples, the generator bath was quenched by adding 400 mg of sodium bisulfite. TEM imaging of the stained cryo-ultramicrotomed cross-sections was performed with a Talos L120C G2 Transmission Electron Microscope operated at 120 kV. An isotropic SEBS control sample was prepared and imaged similarly to validate sample preparation procedures.

Tensile testing was performed on an Instron 5965 equipped with a 500 N load cell. Single filament samples for mechanical analysis were mounted in epoxy pucks with cyanoacrylate adhesive. Single filament sample gauge lengths varied between 20-40 mm. Measurements performed on single-layer 3D printed sheets and isotropic controls were tested using an ASTM 1708 standard dog-bone geometry (17.5 mm×5 mm gauge dimensions). During all tensile testing, strain was applied at 100% min⁻¹ to a maximum strain of 100%. Reported small strain modulus values were extracted from the small strain (0-2%) region and represent averages and standard deviations over 3-5 replicates. Dynamic mechanical analysis (DMA) was performed on a Perkin Elmer DMA-8000 using the single-cantilever geometry at room temperature with an oscillation frequency of 1 s⁻¹, using 3D printed samples of appropriate dimensions (approx. 3.5 mm×5.5 mm×15 mm).

A number of implementations have been described. Nevertheless, it will be understood that various modifications may be made without departing from the spirit and scope of the disclosure. Accordingly, other implementations are within the scope of the following claims.

What is claimed is:

1. A method for printing via a high operating temperature direct ink writing (HOT-DIW) process, comprising:
(a) extruding a filament along a print path by:
(1) causing a filament material to experience a shear rate (γ) of at least 1 s⁻¹ within a print nozzle, the filament material including a thermoplastic elastomer (TPE);
(2) increasing anisotropy by increasing a translational velocity of a print nozzle to achieve a draw ratio (D_{R})>1; and
(b) after extruding the filament, thermally annealing the filament.

2. The method of claim 1, wherein extruding the filament includes extruding an unsupported portion of the filament, where the unsupported portion extends an axial distance that is up to 10 times a diameter of the filament.

3. The method of claim 1, wherein the print path forms a three-dimensional object where at least one portion of the three-dimensional object has at least two macro segments (a) arranged linearly in series with respect to the direction of intended deformation or (b) a combination of segments both in series and in parallel with respect to the direction of intended deformation,
where the at least two macro segments are configured to tune the mechanical functionality of the at least one portion of the three-dimensional object.

4. The method of claim 3, wherein the at least two macro segments includes at least one stiffer segment and at least one softer segment.

5. The method of claim 4, wherein the print path forms multiple layers.

6. The method of claim 5, wherein each at least one stiffer segment comprises at least two layers disposed in a direction parallel to a predetermined direction of tension, compression, or flexion of the at least two layers.

7. The method of claim 5, wherein each at least one softer segment comprises at least two layers are disposed in a direction perpendicular to a predetermined direction of tension, compression, or flexion of the at least two layers.

8. The method of claim 1, wherein the TPE is a multiblock copolymer.

9. The method of claim 8, wherein the TPE is a copolymer having at least one glassy block and at least one elastomeric block.

10. The method of claim 9, wherein the diblock or triblock copolymer is a styrene-ethylene-butylene-styrene (SEBS) polymer.

11. The method of claim 1, wherein the filament material includes the TPE and at least one functional additive material.

12. The method of claim 11, wherein the at least one functional additive material is a fluorescent or phosphorescent material.

13. The method of claim 1, wherein the annealing temperature is a temperature between the glass transition temperature (Tg) and either the degradation temperature or a nearest nanostructural transition temperature.

14. The method of claim 13, wherein annealing is performed for a period of time of no more than 2 weeks.

15. A component formed via three-dimensional (3D) printing, comprising:
at least one layer from a 3D printed filament, the 3D printed filament being composed of an anisotropic nanostructured thermoplastic elastomer (TPE);
where at least one portion of the component has at least two macro segments that are (a) arranged linearly in series with respect to the direction of intended deformation, (b) a combination of segments both in series and in parallel with respect to the direction of intended deformation,
where the at least two macro segments are configured to tune the mechanical functionality of the at least one portion of the component, or where at least one portion of the component has at least one macro segment having programmed anisotropy via extrusion.

16. The component of claim 15, wherein, for a given orientation of the component, the at least two macro segments include at least one stiffer segment and at least one softer segment.

17. The component of claim 16, wherein each at least one stiffer segment comprises at least two layers disposed in a direction parallel to a predetermined direction of tension and compression of the at least two layers.

18. The component of claim 16, wherein each at least one softer segment comprises at least two layers are disposed in a direction perpendicular to a predetermined direction of tension and compression of the at least two layers.

19. The component of claim 15, wherein the anisotropic nanostructured TPE is a copolymer having at least one glassy block and at least one elastomeric block.

20. The component of claim 15, wherein the 3D printed filament being composed is composed of the anisotropic nanostructured TPE and at least one functional additive material.
